(19) United States
(12) Patent Application Publication
(10) Pub. No.: US 2026/0214543 A1
(43) Pub. Date: Jul. 23, 2026

(54) Wireless Device, Network Node, and Methods Performed thereby for Handling Reestablishment Information After a Failure

(71) Applicant: Telefonaktiebolaget LM Ericsson (publ), Stockholm (SE)

(72) Inventors: Ali Parichehrehteroujeni, Linköping (SE); Pradeepa Ramachandra, Linköping (SE); Marco Belleschi, Solna (SE)

(21) Appl. No.: 19/103,352

(22) PCT Filed: Aug. 31, 2023
(86) PCT No.: PCT/SE2023/050863

§ 371 Date: Feb. 12, 2025

Related U.S. Application Data
(60) Provisional application No. 63/374,009, filed on Aug. 31, 2022.

(51) Int. Cl. H04W 36/30; H04W 36/00; H04W 36/04; H04W 36/32

(52) U.S. Cl. CPC H04W 36/305; H04W 36/0058; H04W 36/04; H04W 36/322

(57) ABSTRACT

A method, performed by a wireless device (130). The method is for handling re-establishment information after a radio link failure. The wireless device (130) operates in a wireless communications network (100). The wireless device (130) stores (304), responsive to a declared radio link failure, one or more indications. The one or more indications indicate the radio link failure. The one or more indications comprise at least a first indication. The first indication indicates whether a first cell (123) selected by the wireless device (130) for a reestablishment procedure triggered by the radio link failure, was a candidate cell in an inter-cell mobility configuration. The inter-cell mobility configuration was received in a previous indication to perform an L1/L2 mobility procedure.

### TECHNICAL FIELD

The present disclosure relates generally to a wireless device and methods performed thereby for handling re-establishment information after a failure. The present disclosure further relates generally to a network node and methods performed thereby, for handling re-establishment information after the failure.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### Further NR Mobility Enhancements in 3GPP Rel-18

As part of 3GPP Release 18, a new work item known as Further NR mobility enhancements is about to start. This work item aims, among others, to specify Layer-1 (L1)/Layer-2 (L2)-based inter-cell mobility. According to the Work Item Description (WID) [1], the following is included as one objective of the work: to specify mechanism and procedures of L1/L2 based inter-cell mobility for mobility latency reduction. This may comprise configuration and maintenance for multiple candidate cells to allow fast application of configurations for candidate cells [RAN2, RAN3]. Mechanism and procedures of L1/L2 based inter-cell mobility for mobility latency reduction may also comprise dynamic switch mechanism among candidate serving cells, including Special cell (SpCell) and Secondary Cell (Scell), for the potential applicable scenarios based on L1/L2 signalling [RAN2, RAN1]. Mechanism and procedures of L1/L2 based inter-cell mobility for mobility latency reduction may further comprise L1 enhancements for inter-cell beam management, including L1 measurement and reporting, and beam indication [RAN1, RAN2]. It was noted that early RAN2 involvement may be necessary, including the possibility of further clarifying the interaction between this point with the previous point. Mechanism and procedures of L1/L2 based inter-cell mobility for mobility latency reduction may also comprise timing Advance management [RAN1, RAN2]. Mechanism and procedures of L1/L2 based inter-cell mobility for mobility latency reduction may further comprise Centralized unit (CU)-Distributed unit (DU) interface signaling to support L1/L2 mobility, if needed [RAN3]. It was noted that Frequency 2 (FR2) specific enhancements are not precluded, if any. It was further noted that the procedure of L1/L2 based inter-cell mobility may be applicable to the following scenarios: Standalone, Carrier Aggregation (CA) and NR-Dual Connectivity (DC) case with serving cell change within one Cell Group (CG), intra-DU case and intra-CU inter-DU case, applicable for Standalone and CA: no new RAN interfaces are expected, both intra-frequency and inter-frequency, both Frequency 1 (FR1) and FR2, and source and target cells may be synchronized or non-synchronized.

According to the work item description [1], the following is written as part of the justification: when the UE moves from the coverage area of one cell to another cell, at some point, a serving cell change may need to be performed. Currently, serving cell change may be triggered by L3 measurements and may be done by Radio Resource Control (RRC) signalling triggered Reconfiguration with Synchronisation for change of Primary Cell (PCell) and Primary Secondary Cell (PSCell), as well as release add for SCells when applicable. All cases may involve complete L2, and L1, resets, leading to longer latency, larger overhead and longer interruption time than beam switch mobility. The goal of L1/L2 mobility enhancements may be understood to be to enable a serving cell change via L1/L2 signalling, in order to reduce the latency, overhead and interruption time.

### Self-Organizing Networks (SON) in 3GPP

A Self-Organizing Network (SON) may be understood to be an automation technology designed to make the planning, configuration, management, optimization and healing of mobile radio access networks simpler and faster. SON functionality and behavior has been defined and specified in generally accepted mobile industry recommendations produced by organizations such as 3rd Generation Partnership Project (3GPP) and the Next Generation Mobile Networks (NGMN).

In 3GPP, the processes within the SON area may be classified into Self-configuration process and Self-optimization process. Self-configuration process may be understood as the process where newly deployed nodes may be configured by automatic installation procedures to get the necessary basic configuration for system operation. This process may work in pre-operational state. Pre-operational state may be understood as the state from when the eNB may be powered up and may have backbone connectivity until the Radio Frequency (RF) transmitter may be switched on.

FIG. 1 is a schematic signalling diagram depicting the ramifications of Self-Configuration/Self-Optimization functionality, according to FIGS. 22.1-1 from 3GPP TS 36.300, v. 17.1.0.

As illustrated in FIG. 1, functions handled in the pre-operational state such as basic setup, and initial radio configuration may be covered by the Self Configuration process. As illustrated in FIG. 1, the Basic Setup (A) functions may comprise: a-1) configuration of Internet Protocol (IP) address and detection of Operations, Administration and Maintenance (OAM), a-2) authentication of eNB/Network (NW), a-3) association to a Gateway (GW), a-4) downloading of eNB software (and operational parameters), etc. The Initial Radio Configuration (B) functions may comprise: b-1) neighbour list configuration, b-2) coverage/capacity related parameter configuration, etc.

The Self-optimization process may be defined as the process where User Equipment (UE) and access node measurements and performance measurements may be used to auto-tune the network. This process may work in operational state. Operational state may be understood as the state where the RF interface may be additionally switched on.

As described in FIG. 1, functions handled in the operational state such as optimization/adaptation, may be covered by the Self Optimization process. As illustrated in FIG. 1, the Optimization/Adaptation (C) functions may comprise: c-1) neighbour list optimization, c-2) coverage and capacity control, etc.

In LTE, support for Self-Configuration and Self-Optimisation may be specified, as described in 3GPP TS 36.300, v. 17.1.0 section 22.2, including features such as Dynamic configuration, Automatic Neighbour Relation (ANR), Mobility load balancing, Mobility Robustness Optimization (MRO), Radio Access Channel (RACH) optimization and support for energy saving.

In NR, support for Self-Configuration and Self-Optimisation may be specified as well, starting with Self-Configuration features such as Dynamic configuration, Automatic Neighbour Relation (ANR) in Rel-15, as described in 3GPP TS 38.300, v. 17.1.0 section 15. In NR Rel-16, more SON features are being specified for NR UEs, including Self-Optimisation features such as Mobility Robustness Optimization (MRO).

### Mobility Robustness Optimization (MRO) in 3GPP

Seamless handovers may be understood to be a key feature of 3GPP technologies. Successful handovers may ensure that the UE may move around in the coverage area of different cells without causing too many interruptions in the data transmission. However, there may be scenarios when the network may fail to handover the UE to the ‘correct’ neighbor cell in time, and in such scenarios, the UE may declare the radio link failure (RLF) or Handover Failure (HOF).

Upon HOF and RLF, the UE may take autonomous actions, such as trying to select a cell and initiate reestablishment procedure so that it may be ensured that the UE is trying to get back as soon as it can, so that it may be reachable again. The RLF may be understood to cause a poor user experience, as the RLF may be declared by the UE only when it may realize that there may be no reliable communication channel, that is, radio link, available between itself and the network. Also, reestablishing the connection may require signaling with the newly selected cell, such as random access procedure, RRC Reestablishment Request, RRC Reestablishment RRC Reestablishment Complete, RRC Reconfiguration and RRC Reconfiguration Complete, and may add some latency, until the UE may be able to exchange data with the network again.

According to the specifications, e.g., 3GPP TS 36.331, v. 17.1.0, the possible causes for the radio link failure may be one of the following: a) expiry of the radio link monitoring related timer T310, b) expiry of the measurement reporting associated timer T312, that is, not receiving the handover command from the network within the duration of this timer despite sending the measurement report when T310 was running, c) upon reaching the maximum number of Radio Link Control (RLC) retransmissions, and d) upon receiving random access problem indication from the Medium Access Control (MAC) entity.

As RLF may be understood to lead to reestablishment, which may degrade performance and user experience, it may be understood to be in the interest of the network to understand the reasons for RLF, and try to optimize mobility related parameters, e.g., trigger conditions of measurement reports, to avoid later RLFs. Before the standardization of MRO related report handling in the network, only the UE was aware of some information associated to how the radio quality looked like at the time of RLF, what was the actual reason for declaring RLF etc. For the network to identify the reason for the RLF, the network may be understood to have needed more information, both from the UE and also from the neighboring base stations.

As part of the MRO approach in LTE, the RLF reporting procedure was introduced in the RRC specification in Rel-9 RAN2 work. That has impacted the RRC specifications, e.g., TS 36.331, v. 17.1.0, in the sense that it was standardized that the UE would log relevant information at the moment of an RLF and later report to a target cell the UE may have succeeded to connect, e.g., after reestablishment. That has also impacted the inter-gNodeB interface, that is, X2AP specifications, e.g., 3GPP TS 36.423, v. 17.1.0, as an eNodeB receiving an RLF report may forward it to the eNodeB where the failure may have been originated.

For the RLF report generated by the UE, its contents have been enhanced with more details in the subsequent releases. The measurements included in the measurement report based on the latest LTE RRC specification [1] may be: a) measurement quantities, such as Reference Signal Received Power (RSRP), Reference Signal Received Quality (RSRQ) of the last serving cell, e.g., PCell, b) measurement quantities of the neighbor cells in different frequencies of different RATs, e.g., Evolved Universal Terrestrial Radio Access (EUTRA), Universal Terrestrial Radio Access (UTRA), Global System for Mobile communications Enhanced Data Rates for GSM Evolution Radio Access Network (GERAN), Code Division Multiple Access 2000 (CDMA2000), c) measurement quantity Received Signal Strength Indicator (RSSI) associated to Wireless Local Area Network (WLAN) Access Points (Aps), d) measurement quantity, e.g., RSSI associated to Bluetooth beacons, e) location information, if available, including location coordinates and velocity, f) globally unique identity of the last serving cell, if available, otherwise the Physical cell identifier (PCI) and the carrier frequency of the last serving cell, g) tracking area code of the PCell, h) time elapsed since the last reception of the ‘Handover command’ message, i) Cell Radio Network Temporary Identifier (C-RNTI) used in the previous serving cell, j) whether or not the UE was configured with a Data Radio Bearer (DRB) having Quality of Service Class Identifier (QCI) value of 1.

After the RLF is declared, the RLF report may be logged and included in the VarRLF-Report and, once the UE may select a cell and succeed with a reestablishment, it may include an indication that it has an RLF report available in the RRC Reestablishment Complete message, to make the target cell aware of that availability. Then, upon receiving an UEInformationRequest message with a flag “rlf-ReportReq-r9” the UE may be required to include the RLF report, e.g., stored in a UE variable VarRLF-Report, as described above, in an UEInformationResponse message and send it to the network.

Based on the RLF report from the UE and the knowledge about in which cell did the UE reestablish itself, the original source cell may be able to deduce whether the RLF was caused due to a coverage hole, or due to handover associated parameter configurations. If the RLF was deemed to be due to handover associated parameter configurations, the original serving cell may further classify the handover related failure as too-early, too-late or handover to wrong cell classes. These handover failure classes are explained in brief below. A first handover failure class may be regarding whether the handover failure occurred due to the ‘too-late handover/mobility’ cases. The original serving cell may classify a handover failure to be ‘too late handover/mobility’ when the original serving cell may fail to send the handover command to the UE associated to a handover towards a particular target cell and if the UE reestablishes itself in this target cell post RLF. An example corrective action from the original serving cell may be to initiate the handover procedure towards this target cell a bit earlier by decreasing the cell individual offset (CIO) towards the target cell that may control when the Information Element (IE) may send the event triggered measurement report that may lead to taking the handover decision.

A second handover failure class may be regarding whether the handover failure occurred due to the ‘too-early handover/mobility’ cases. The original serving cell may classify a handover failure to be ‘too early handover/mobility’ when the original serving cell may be successful in sending the handover command to the UE associated to a handover, however the UE may fail to perform the random access towards this target cell or the UE may declare RLF in the target cell soon afterwards. An example corrective action from the original serving cell may be to initiate the handover procedure towards this target cell a bit later by increasing the cell individual offset (CIO) towards the target cell that may control when the IE may send the event triggered measurement report that may lead to taking the handover decision.

A third handover failure class may be regarding whether the handover failure occurred due to the ‘handover/mobility-to-wrong-cell’ cases. The original serving cell may classify a handover failure to be ‘handover/mobility-to-wrong-cell’ when the original serving cell may intend to perform the handover for this UE towards a particular target cell, but the UE may declare failure or may declare failure shortly after successfully completing the handover and then may reestablish itself in a third cell. A corrective action from the original serving cell may be to initiate the measurement reporting procedure that may lead to handover towards the target cell a bit later by decreasing the CIO towards the target cell, or via initiating the handover towards the cell in which the UE reestablished a bit earlier by increasing the CIO towards the reestablishment cell.

Existing methods to handle handover failure may result in wasted resources, such as unnecessary signaling and/or unnecessary delays.

### SUMMARY

As part of the development of embodiments herein, one or more challenges with the existing technology will first be identified and discussed.

For what is in the work item description, WID [1], in 3GPP referred to as L1/L2 based inter-cell mobility, the overall procedure and signaling is still open. A goal of L1/L2 based inter-cell mobility is to reduce latency, overhead and interruption time. The L1/L2 inter-cell mobility decisions may be taken by the source DU, in comparison with the legacy L3 mobility decisions which may have been taken by the source CU-Control Plane (CP). The L1/L2 inter-cell mobility candidates may be expected to be configured in a UE specific way. A UE may have limitations on how many inter-cell mobility candidates it may keep in the memory, e.g., 8 L1/L2 inter-cell mobility candidates, and thus different UEs in the same DU may be configured with different candidate L1/L2 inter-cell mobility candidates depending on the location, mobility characteristics and other parameters of the UE.

When the UE may declare an RLF, the UE may perform reestablishment procedure. It may be possible that the cell in which the UE may perform the reestablishment procedure may have been a candidate for L1/L2 inter-cell mobility. If that is the case, then this may imply that the L1/L2 inter-cell mobility decision making may not have been optimal, as the UE had to declare failure to come back to connected in the reestablishment cell, instead of being instructed via L1/L2 to perform mobility towards the reestablishment cell. However, with the current RLF report contents, the network may not be able to know whether the UE may have been configured with the reestablishment cell as a candidate for the L1/L2 inter-cell mobility or not. Thus, the network may not be able to get to know whether the problem may lie in the L1/L2 inter-cell mobility triggering at the DU or the L1/L2 inter-cell mobility candidate selection or the L3 mobility configurations.

Certain aspects of the present disclosure and their embodiments may provide solutions to these or other challenges.

According to the foregoing, it is an object of embodiments herein to improve the handling of re-establishment information after a failure.

According to a first aspect of embodiments herein, the object is achieved by a method, performed by a wireless device. The method is for handling re-establishment information after a failure. The wireless device operates in a wireless communications network. The wireless device stores, responsive to a declared failure, one or more indications. The one or more indications indicate the failure. The one or more indications comprise at least a first indication. The first indication indicates whether a first cell, selected by the wireless device for a reestablishment procedure triggered by the failure, was a candidate cell in an inter-cell mobility configuration. The inter-cell mobility configuration was received in a previous indication to perform an L1/L2 mobility procedure.

According to a second aspect of embodiments herein, the object is achieved by a method, performed by a network node. The method is for handling the re-establishment information after the failure by the wireless device. The network node operates in the wireless communications network. The network node receives from the wireless device, the one or more indications. The one or more indications indicate the failure. The one or more indications comprise at least the first indication. The first indication indicates whether the first cell selected by the wireless device for the reestablishment procedure triggered by the failure, was a candidate cell in the inter-cell mobility configuration. The inter-cell mobility configuration was received by the wireless device in the previous indication to perform the L1/L2 mobility procedure.

According to a third aspect of embodiments herein, the object is achieved by the wireless device, configured to perform the method. The wireless device may be understood to be for handling the re-establishment information after the failure. The wireless device is configured to operate in the wireless communications network. The wireless device is configured to store, responsive to the declared failure, the one or more indications configured to indicate the failure. The one or more indications are configured to comprise at least the first indication. The first indication is configured to indicate whether the first cell configured to be selected by the wireless device for the reestablishment procedure configured to be triggered by the failure, was a candidate cell in the inter-cell mobility configuration configured to be received in the previous indication. The previous indication is to perform the L1/L2 mobility procedure.

According to a fourth aspect of embodiments herein, the object is achieved by the network node, configured to perform the method. The network node may be understood to be for handling the re-establishment information after the failure by the wireless device. The network node is configured to operate in the wireless communications network. The network node is configured to receive from the wireless device, the one or more indications configured to indicate the failure. The one or more indications are configured to comprise at least the first indication. The first indication is configured to indicate whether the first cell configured to be selected by the wireless device for the reestablishment procedure configured to be triggered by the failure, was a candidate cell in the inter-cell mobility configuration. The inter-cell mobility configuration is configured to be received by the wireless device in the previous indication to perform the L1/L2 mobility procedure.

By storing the one or more indications, the wireless device may then be enabled to send the stored one or more indications to the network node. By receiving the one or more indications, the network node may be enabled to identify, based on the one or more indications stored in embodiments herein, whether a cell wherein the wireless device may later perform reestablishment, e.g., the first cell, was part of the L1/L2 inter-cell mobility configuration or not. The wireless device may thereby enable the network node to know whether the problem may lie in the L1/L2 inter-cell mobility triggering at the DU or the L1/L2 inter-cell mobility candidate selection or the L3 mobility configurations. The network node may thereby be enabled to make adjustments to the L1/L2 inter-cell mobility configuration according to its analysis of the one or more indications. This may in turn result in optimized mobility procedures, with reduced latency, shorter interruptions in communications, and more efficient usage of resources in the wireless communications network.

### BRIEF DESCRIPTION OF THE DRAWINGS

Examples of embodiments herein are described in more detail with reference to the accompanying drawings, according to the following description.

FIG. 1 is a schematic signalling diagram depicting the ramifications of Self-Configuration/Self-Optimization functionality, according to FIGS. 22.1-1 from 3GPP TS 36.300, v. 17.1.0.

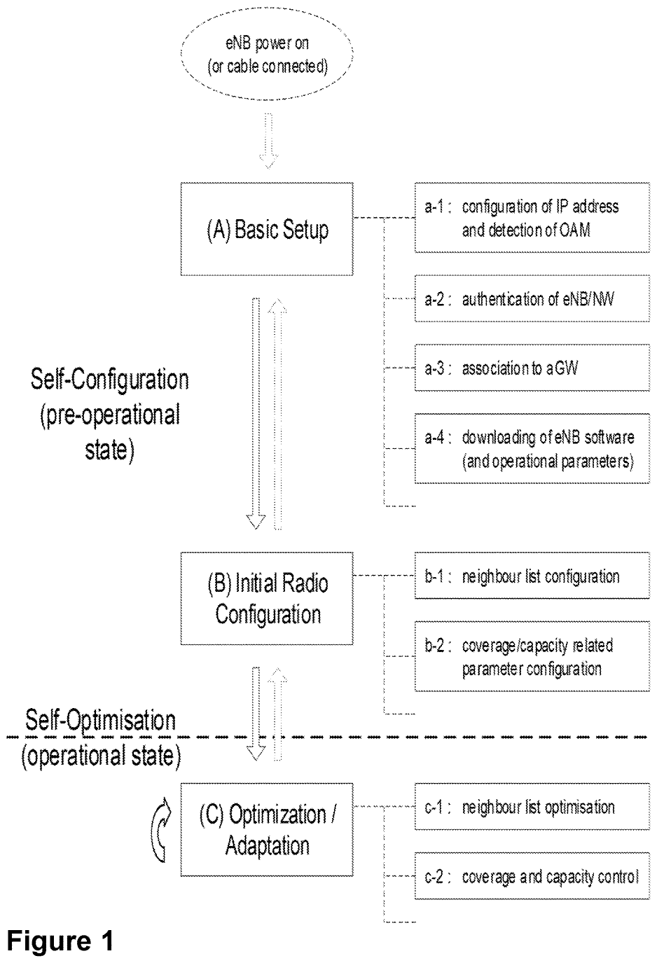

FIG. 2 is a schematic diagram depicting an example of a wireless communications network, according to embodiments herein.

FIG. 3 is a flowchart depicting a method in a wireless device, according to embodiments herein.

FIG. 4 is a flowchart depicting a method in a network node, referred to herein as a “third network node”, according to embodiments herein.

FIG. 5 is a schematic block diagram illustrating two embodiments, in panel a) and panel b), of a wireless device, according to embodiments herein.

FIG. 6 is a schematic block diagram illustrating two embodiments, in panel a) and panel b), of a network node, according to embodiments herein.

FIG. 7 is a flowchart depicting a method in a wireless device, according to examples related to embodiments herein.

FIG. 8 is a flowchart depicting a method in a network node, referred to herein as a “third network node”, according to examples related to embodiments herein.

FIG. 9 shows an example of a communication system 900 in accordance with some embodiments.

FIG. 10 is a block diagram of a host 1000, which may be an embodiment of the host 916 of FIG. 9, in accordance with various aspects described herein.

FIG. 11 shows a communication diagram of a host 1102 communicating via a network node 1104 with a UE 1106 over a partially wireless connection in accordance with some embodiments.

### DETAILED DESCRIPTION

Embodiments herein may be generally understood to relate to re-establishment cell type information with L1/L2 inter-cell mobility configuration. Embodiments herein may be understood to enable the enhancement of, a report, e.g., an RLF report, with an indication indicating whether the cell in which the reestablishment procedure was performed was a L1/L2 inter-cell mobility candidate or not.

Embodiments herein may further enable the inclusion of all the configured L1/L2 inter-cell mobility candidates and measurements pertaining to them as part of the report, e.g., RLF report.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

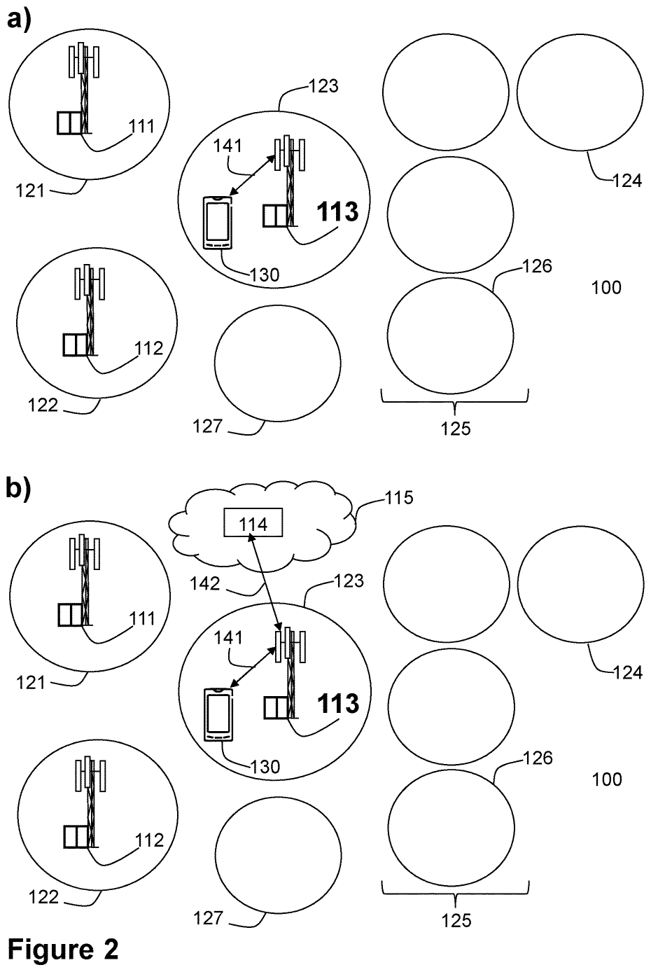

FIG. 2 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may in addition, support other technologies such as, for example, Long-Term Evolution (LTE), e.g., LTE for Machines (LTE-M), LTE Frequency Division Duplex (FDD), LTE Time Division Duplex (TDD), LTE Half-Duplex Frequency Division Duplex (HD-FDD), LTE operating in an unlicensed band, such as LTE Licensed Assisted Access (LAA), enhanced LAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), Machine Type Communication (MTC), enhanced MTC (eMTC), Internet of Things (IoT) and/or Narrow Band IoT (NB-IoT) or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a first network node 111, a second network node 112, and a third network node 113 are depicted in the non-limiting example of FIG. 2. Any of the first network node 111, the second network node 112 and the third network node 113 may be a radio network node. That is, a transmission point such as a radio base station, for example a gNB, or an eNB, or any other network node with similar features capable of serving a user equipment, such as a wireless device or a machine type communication device, in the wireless communications network 100. In some examples, such as that depicted in FIG. 2 b for the third network node 113, any of the first network node 111, the second network node 112 and the third network node 113 may be a distributed node, and may partially perform its functions in collaboration with a virtual node 114 in a cloud 115. The third network node 113 may be referred to herein simply as the network node 113. This will be further explained in relation to Action 306.

The wireless communications network 100 may cover a geographical area, which in some embodiments may be divided into cell areas, wherein each cell area may be served by a radio network node, although, one radio network node may serve one or several cells. In the example of FIG. 2, the first network node 111 may serve a source cell 121, the second network node 112 may serve a target cell 122, and the third network node 113 may serve a respective cell. In the non-limiting example depicted in FIG. 2, the respective cell served by the third network node 113 is a first cell 123, which may be referred to herein simply as the cell 123. However, this may not necessarily be the case. The respective cell served by the third network node 113 may be a cell other than the first cell 123. Any of the first network node 111, the second network node 112 and the third network node 113 may be of different classes, such as, e.g., macro base station, home base station or pico base station, based on transmission power and thereby also cell size. In some examples, any of the first network node 111, the second network node 112 and the third network node 113 may serve receiving nodes with serving beams. Any of the first network node 111, the second network node 112 and the third network node 113 may support one or several communication technologies, and its name may depend on the technology and terminology used. Any of the radio network nodes that may be comprised in the communications network 100 may be directly connected to one or more core networks, e.g., to one or more network nodes in the one or more core networks.

In some examples, any of the source cell 121, the target cell 122 and the first cell 123 may be served by one or more beams.

In some examples the first network node 111, the second network node 112 and the third network node 113 may be different network nodes.

In some examples, any of the first network node 111, the second network node 112 and the third network node 113 may be co-located or be the same node.

The wireless communications network 100 may further comprise a second cell 124, one or more candidate cells 125, which may comprise a first candidate cell 126, and a first neighbor cell 127. The one or more candidate cells 125 are depicted in FIG. 2 as comprising three cells. However, this may be understood to be for illustrative purposes and non-limiting. The one or more candidate cells 125 may comprise fewer or additional cells. It may also be understood that the wireless communications network 100 may comprise other cells. To simplify the figure, the network nodes respectively serving the cells which are depicted are not illustrated. One or more of the cells depicted may be served by the same network node.

A plurality of wireless devices may be located in the wireless communication network 100, whereof a wireless device 130, is depicted in the non-limiting example of FIG. 2. The wireless device 130 comprised in the wireless communications network 100 may be a wireless communication device such as a 5G User Equipment (UE) or nUE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

The wireless device 130 may be configured to communicate within the wireless communications network 100 with the third network node 113 over a first link 141, e.g., a radio link. The third network node 113 may be configured to communicate within the wireless communications network 100 with the virtual network node 114 over a second link 142, e.g., a radio link or a wired link. Although not depicted in FIG. 2, the wireless device 130 may be configured to communicate within the wireless communications network 100 with the first network node 111 over a third link, e.g., a radio link, and the wireless device 130 may be configured to communicate within the wireless communications network 100 with the second network node 112 over a fourth link, e.g., a radio link. It may be understood that the wireless device 130 may communicate with the cells depicted in FIG. 2 over a respective link, e.g., a radio link. This is not depicted to simplify the figure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth” and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the third network node 113, e.g., a gNB.

Some embodiments herein will now be further described with some non-limiting examples.

In the following description, any reference to a/the UE, or simply “UE” may be understood to equally refer the wireless device 130; any reference to a/the gNB, and/or a/the network may be understood to equally refer to the network node 113.

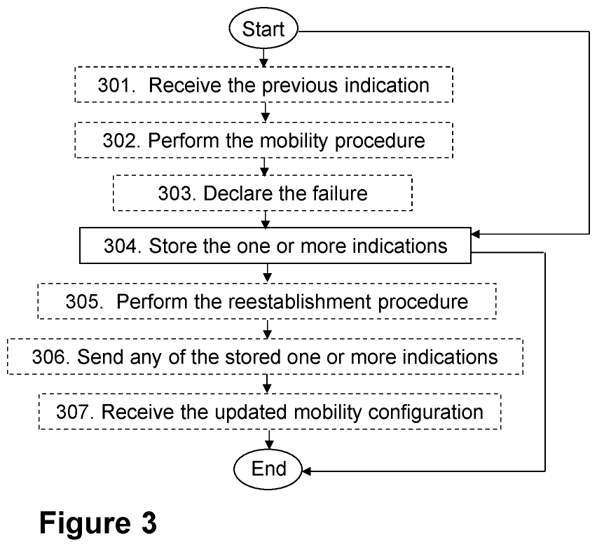

Embodiments of a method, performed by a wireless device, such as the wireless device 130, will now be described with reference to the flowchart depicted in FIG. 3. The method may be understood to be for handling re-establishment information after a failure.

The failure may be in a mobility procedure.

The mobility procedure may be, e.g., an L1/L2 mobility procedure.

The failure may be a radio link failure or a handover failure.

The failure may be in a mobility procedure by the wireless device 130, e.g., from the first network node 111 to the second network node 112. A failure in a mobility procedure may be understood as that something went wrong in the handling of the mobility, e.g., L1/L2 mobility. What may have gone wrong may have been a radio link failure or a handover failure. A mobility procedure may also be referred to herein simply as mobility.

From the first network node 111 to the second network node 112 may mean, in some examples, that the mobility is inter-cell. However, it may be noted, as described above, that the first network node 111 and the second network node 112 may be the same node in some examples.

The radio link failure may be an example of a failure in a mobility procedure by the wireless device 130, e.g., from the first network node 111 to the second network node 112. The wireless device 130 operates in a wireless communications network, such as the wireless communications network 100. The method may be understood to be computer-implemented.

In some particular embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 3. In FIG. 3, optional actions in some embodiments may be represented with dashed lines. In some embodiments, the actions may be performed in a different order than that depicted FIG. 3.

### Action 301

In this Action 301, the wireless device 130 may receive a previous indication. The previous indication may be to perform an L1/L2 mobility procedure. The previous indication may comprise an inter-cell mobility configuration received to perform the L1/L2 mobility procedure.

In a non-limiting example, an L1/L2 mobility procedure may be understood as a mobility procedure involving L1 and/or L2 signalling.

The receiving in this Action 301 may be from the first network node 111. In other related examples, the receiving in this Action 301 may be, e.g., from the second network node 112, or from another network node operating in the wireless communications network 100.

This may be understood to mean that the wireless device 130 may receive the previous indication from the same network node to which it may eventually send a report on the failure, although the network node from which it may receive the previous indication may be a different network node.

### Action 302

In this Action 302, the wireless device 130 may perform the L1/L2 inter-cell mobility procedure. The performing in this Action 302 may be, e.g., responsive to the received previous indication.

The mobility procedure may be from the first network node 111 to the second network node 112 operating in the wireless communications network 100, e.g., from the source cell 121 to the target cell 122.

### Action 303

In this Action 303, the wireless device 130 may declare the failure in the mobility procedure. The failure may be, e.g., radio link failure. That is, in this Action 303, the wireless device 130 may declare the radio link failure. It may be understood that the radio link failure of embodiments herein may not necessarily take place during the course or attempt of a handover from the source cell 121 to the target cell 122. Occurrence of the radio link failure during such a handover may just be one example of when the radio link failure may happen. As stated earlier, in some examples, any of the first network node 111, the second network node 112 and the third network node 113 may be co-located or be the same node. Accordingly, another example wherein the radio link failure may happen may be in the same cell where the wireless device 130 received the configuration in Action 301.

As mentioned above, the failure may be a HOF. In such examples, the wireless device 130, in this Action 303, may declare the HOF.

### Action 304

In this Action 304, the wireless device 130 stores one or more indications. Storing may comprise, e.g., logging or recording. The storing/logging/recording in this Action 304 is responsive to the declared failure. The one or more indications indicate the failure. That is, the one or more indications indicate the failed mobility procedure in the sense of the mobility procedure wherein something went wrong. A failed mobility procedure may be understood herein, in some examples, as an L1/L2 mobility procedure wherein something, e.g., an RLF and or an HOF, may have gone wrong.

The one or more indications comprise at least a first indication indicating whether a cell, e.g., the first cell 123, selected by the wireless device 130 for a reestablishment procedure triggered by the failure, that is, the failed mobility procedure, was a candidate cell in the inter-cell mobility configuration received in the previous indication to perform the L1/L2 mobility procedure. That is, the mobility procedure that failed.

Triggered by the failed mobility procedure may be understood as triggered by the L1/L2 mobility procedure wherein something, e.g., RLF/HOF, may have gone wrong.

As stated earlier, the previous indication may have been received, e.g., from the first network node 111, from the second network node 112, or from another network node operating in the wireless communications network 100.

In some embodiments, the one or more indications may further comprise at least one of the following options. According to a first option, the one or more indications may further comprise a second indication. The second indication may indicate one or more candidate cells 125 as configured in the inter-cell mobility, e.g., L1/L2 inter-cell mobility, configuration.

According to a second option, the one or more indications may further comprise a third indication. The third indication may indicate a time elapsed between a first time of reception of the inter-cell mobility, e.g., L1/L2 inter-cell mobility, configuration in Action 301, and a second time when the failure, e.g., radio link failure, was declared in Action 303.

In one example, a timer may be started at reception of the last L1/L2 inter-cell mobility configuration before the failure; in an alternative example, this timer may be started at reception of the last L1/L2 inter-cell mobility configuration including, as candidate cell, the cell selected for reestablishment procedure. According to a third option, the one or more indications may further comprise the third indication, further indicating a third time elapsed between a fourth time of reception of a last inter-cell mobility, e.g., L1/L2 inter-cell mobility, configuration including, as candidate cell, the first cell 123 selected for the reestablishment procedure, and the second time when the failure, e.g., radio link failure, was declared.

According to a fourth option, the one or more indications may further comprise a fourth indication. The fourth indication may indicate at least one of: a) first location information at the fourth time, and b) second location information at the second time.

In some embodiments, at least one of the following options may apply. According to a first option, the first indication may be indicated by a one-bit flag. According to a second option, the first indication may be indicated by a reest-L1L2Candidate information element (IE). In some examples, such an indication may be a one-bit flag, e.g., reest-L1L2Candidate in the example implementation provided below, in the description of the Action 306.

According to a third option, the first indication may further indicate additional L1/L2 mobility related measurements.

According to a fourth option, the first indication with the additional L1/L2 mobility related measurements may be indicated by a reest-L1L2meas IE. In some examples, an explicit indication with additional L1/L2 mobility related measurements, e.g., reest-L1L2meas in the example implementation below may be used.

According to a fifth option, the first indication with the additional L1/L2 mobility related measurements may be indicated by a reConnect-L1L2meas.

According to a sixth option, the second indication may be indicated by a candidates-L1L2Mobility IE. According to a seventh option, the second indication may be indicated by a candidate-L1L2flag flag.

According to an eighth option, the second indication may further indicate the additional L1/L2 mobility related measurements. This may be understood to mean that the second indication, and not the first indication, may further indicate the additional L1/L2 related measurements. It may be understood to not mean that the second indication may indicate the same additional L1/L2 mobility related measurements as the first indication.

According to a ninth option, the second indication with the additional L1/L2 mobility related measurements may be indicated by a candidate-L1L2meas IE. According to a tenth option, the third indication may be indicated by another IE. According to an eleventh option, the fourth indication may be indicated by yet another IE.

By storing the one or more indications in this Action 304, the wireless device 130 may then be enabled to send the stored one or more indications to the network node 113. This may in turn enable the network, e.g., the network node 113, to identify, based on the one or more indications stored in embodiments herein, whether a cell wherein the wireless device 130 may later perform reestablishment, e.g., the first cell 123, was part of the L1/L2 inter-cell mobility configuration or not. The wireless device 130 may thereby enable the network, e.g., the network node 113 to know whether the problem may lie in the L1/L2 inter-cell mobility triggering at the DU or the L1/L2 inter-cell mobility candidate selection or the L3 mobility configurations. The network node 113 may thereby be enabled to make adjustments to the L1/L2 inter-cell mobility configuration according to its analysis of the one or more indications. This may in turn result in optimized mobility procedures, with reduced latency, shorter interruptions in communications, and more efficient usage of resources in the wireless communications network 100.

### Action 305

In this Action 305, the wireless device 130 may perform the reestablishment procedure or reconnection procedure. The reestablishment procedure or reconnection procedure may be, to the third network node 113 operating in the wireless communications network 100.

The performing in this Action 305 may be, e.g., responsive to the declared failure.

In some embodiments, one of the following may apply. According to a first option, the wireless device 130 may perform the reestablishment procedure after going to idle mode or after the radio link failure. That is, the failed mobility procedure. According to a second option, the reestablishment procedure may fail and the wireless device 130 may reconnect to the network node 113, e.g., the third network node 113. In some of these embodiments, the storing in Action 304 may further comprise storing at least one of the following indications. According to a first option, a fifth indication; the fifth indication may indicate whether a second cell 124 selected by the wireless device 130 for a reconnection procedure triggered by the failed reestablishment procedure, was a candidate cell in the inter-cell mobility configuration received in the previous indication. According to a first option, the storing in Action 304 may further comprise storing a sixth indication; the sixth indication may indicate a time elapsed between the first time of reception of the inter-cell mobility, e.g., L1/L2 inter-cell mobility, configuration, and a fifth time of the reconnection upon selection of the second cell 124.

Embodiments herein enable that the wireless device 130 may include an indication about whether the reconnect cell, e.g., the cell the wireless device 130 selected to connect to after a re-establishment failure and transition to the RRC IDLE mode, was a candidate for L1/L2 inter-cell mobility or not. In some examples, such an indication may be a one-bit flag, e.g., reConnect-L1L2Candidate. In some embodiments, the fifth indication may be indicated by a reConnect-L1L2Candidate IE.

### Action 306

In this Action 306, the wireless device 130 may send any of the stored one or more indications to a network node 113 operating in the wireless communications network 100. The sending in this Action 306 may be, e.g., to the third network node 113, which may also be referred to simply as the network node 113. The third network node 113 may be serving the wireless device 130 in the wireless communications network 100.

The network node 113 may be understood to refer herein to the network mode that may receive the one or more indications from the wireless device 130. In general, this will be the same network node as the third network node 113. If the reestablishment procedure of Action 305 is successful, the network node 113 may be the third network node 113. If the reestablishment procedure fails, the wireless device 130 may, in some example, reconnect to the third network node 113, whereas in other examples, the wireless device 130 may reconnect to a network node other than the third network node 113, in which case, the sending in this Action 306 may be to a different network node than the third network node 113. This distinction may be indicated herein as (third) network node 113.

The sending in this Action 306 may be performed, e.g., via the first link 141.

The sent one or more indications may be, e.g., a subset selected from the stored one or more indications.

In some embodiments, at least one of the following options may apply. According to a first option, the failure may be a mobility procedure. According to a second option, the failure may be one of: a radio link failure and a handover failure. According to a third option, the mobility, e.g., the mobility procedure, may be an L1/L2 inter-cell mobility. According to a fourth option, the one or more indications may be sent in a report, e.g., an RLF report. According to a fifth option, the one or more indications may be sent in a UEInformationResponse message. According to a sixth option, the inter-cell mobility configuration may be an L1/L2 inter-cell mobility configuration.

As stated earlier, embodiments herein may enable the wireless device 130 to include an indication, the first indication, about whether the reestablishment cell, e.g., the first cell 123, was a candidate for L1/L2 inter-cell mobility or not. The inclusion of reest-L1L2meas may implicitly indicate to the network that the reestablishment cell was a candidate for the L1/L2 inter-cell mobility at the time of declaring RLF.

In some examples of embodiments herein, in the RLF report, the wireless device 130 may include the L1/L2 inter-cell mobility candidates as configured at the time of declaring RLF, e.g., candidates-L1L2Mobility in the example implementation below. In some examples, this may be a flag, e.g., candidate-L1L2flag in the example implementation below, in the neighbor cell related information included in the RLF report, e.g., in the measurement results associated to the neighbouring cells, and the flag may indicate that the corresponding neighbor cell was a L1/L2 inter-cell mobility candidate or not.

In some examples, the wireless device 130 may include an indication, the third indication, indicating the time elapsed since the configuration of the L1/L2 inter-cell mobility and the radio link failure. In another example, the wireless device 130 may include an indication, the fourth indication, indicating the location information at the time of reception of the last L1/L2 mobility configuration, beside the location information at the time of the radio link failure.

In some examples, the wireless device 130 may include the measurements, e.g., candidate-L1L2meas in the example implementation below, associated to the L1/L2 inter-cell mobility configuration as part of the RLF report.

In some examples, some of the above information, e.g., the list of candidate L1/L2 cells, the measurement results of the L1/L2 cells, the flag indicating whether a measured neighbour cell was a candidate L1/L2 cell, the time elapsed since the L1/L2 mobility configuration, etc, may be included irrespective of whether the wireless device 130 may successfully perform a reestablishment in a cell which was a candidate cell in the L1/L2 mobility configuration, or in a cell which was not a candidate cell for L1/L2 mobility, or it goes in idle mode upon unsuccessful reestablishment attempt, or upon no suitable cell found.

Any of the fifth indication and the sixth indication may be optionally sent, e.g., to the third network node 113.

Some embodiments may concern the reconnect cell, e.g., the second cell 124, in case of re-establishment failure or not finding a suitable cell while the supervision timer e.g., T311 was running.

Embodiments herein may enable that the wireless device 130 may include an indication about whether the reconnect cell, e.g., the cell wireless device 130 selected to connect to after a re-establishment failure and transition to the RRC IDLE mode, was a candidate for L1/L2 inter-cell mobility or not. In some examples, such an indication may be a one-bit flag, e.g., reConnect-L1L2Candidate.

In some examples, the wireless device 130 may send an explicit indication with additional L1/L2 mobility related measurements, e.g., reConnect-L1L2meas. The inclusion of reConnect-L1L2meas may implicitly indicate to the network that the reconnect cell was a candidate for the L1/L2 inter-cell mobility at the time of declaring RLF.

In some examples, the wireless device 130 may include an indication indicating the time elapsed since the configuration of the L1/L2 inter-cell mobility and the time of reconnection right upon cell selection. In one example, this time may be started at reception of the last L1/L2 inter-cell mobility configuration before the failure; in an alternative example, this timer may be started at reception of the last L1/L2 inter-cell mobility configuration including, as candidate cell, the cell selected for reconnection procedure after re-establishment failure. In some examples, some of the above information, e.g., the list of candidate L1/L2 cells, the measurement results of the L1/L2 cells, the flag indicating whether a measured neighbour cell was a candidate L1/L2 cell, the time elapsed since the L1/L2 mobility configuration, etc, may be included irrespective of whether the wireless device 130 may perform a reconnection in a cell which was a candidate cell in the L1/L2 mobility configuration, or in a cell which was not a candidate cell for L1/L2 mobility.

In another example, the wireless device 130 may include an indication indicating the location information at the time of reception of the last L1/L2 mobility configuration, beside the location information at the time of reconnection to the network after re-establishment failure.

### Example Implementation

An example implementation of the above examples concerning the re-establishment cell is given below, wherein TS 38.331 v17.0.0 is taken as the baseline. It may be noted that the below example implementation tries to cover all the above examples and only parts of this example implementations, that is, only those pertaining to certain examples or example combinations, may be implemented in the final specifications. In the example implementation provided, the wireless device 130 is a UE. The network node 113, e.g., the third network node 113 may be understood as an example of the network.

The UEInformationResponse message may be used by the UE to transfer information requested by the network.
Signalling radio bearer: SRB1 or SRB2, when logged measurement information is included
RLC-SAP: AM
Logical channel: DCCH
Direction: UE to network

UEInformationResponse message

-- ASN1START
-- TAG-UEINFORMATIONRESPONSE-START

| | |
|---|---|
| UEInformationResponse-r16 ::= | SEQUENCE { |
| rrc-TransactionIdentifier | RRC-TransactionIdentifier, |
| criticalExtensions | CHOICE { |
| ueInformationResponse-r16 | UEInformationResponse-r16-IEs, |
| criticalExtensionsFuture | SEQUENCE { } |

}
}

| UEInformationResponse-r16-IEs ::= | SEQUENCE { | |
|---|---|---|
| measResultIdleEUTRA-r16 | MeasResultIdleEUTRA-r16 | OPTIONAL, |
| measResultIdleNR-r16 | MeasResultIdleNR-r16 | OPTIONAL, |
| logMeasReport-r16 | LogMeasReport-r16 | OPTIONAL, |
| connEstFailReport-r16 | ConnEstFailReport-r16 | OPTIONAL, |
| ra-ReportList-r16 | RA-Report-List-r16 | OPTIONAL, |
| rlf-Report-r16 | RLF-Report-r16 | OPTIONAL, |
| mobilityHistoryReport-r16 | MobilityHistoryReport-r16 | OPTIONAL, |
| lateNonCriticalExtension | OCTET STRING | OPTIONAL, |
| noncriticalExtension | UEInformationResponse-v1700-IEs | OPTIONAL |

}

| RLF-Report-r16 ::= | CHOICE { | |
|---|---|---|
| nr-RLF-Report-r16 | SEQUENCE { | |
| measResultLastServCell-r16 | MeasResultRLFNR-r16, | |
| measResultNeighCells-r16 | SEQUENCE { | |
| measResultListNR-r16 | MeasResultList2NR-r16 | OPTIONAL, |
| measResultListEUTRA-r16 | MeasResultList2EUTRA-r16 | OPTIONAL |

| | |
|---|---|
| } | OPTIONAL, |
| c-RNTI-r16 | RNTI-Value, |
| previousPCellId-r16 | CHOICE { |
| nrPreviousCell-r16 | CGI-Info-Logging-r16, |
| eutraPreviousCell-r16 | CGI-InfoEUTRALogging |

| | |
|---|---|
| } | OPTIONAL, |

| | |
|---|---|
| failedPCellId-r16 | CHOICE { |
| nrFailedPCellId-r16 | CHOICE { |
| cellGlobalId-r16 | CGI-Info-Logging-r16, |
| pci-arfCn-r16 | SEQUENCE { |
| physCellId-r16 | PhysCellId, |
| carrierFreq-r16 | ARFCN-ValueNR |

```
        }
      },
```

| | |
|---|---|
| eutraFailedpCellId-r16 | CHOICE { |
| cellGlobalId-r16 | CGI-InfoEUTRALogging, |
| pci-arfcn-r16 | SEQUENCE |
| physCellId-r16 | EUTRA-PhysCellId, |
| carrierFreq-r16 | ARECN-ValueEUTRA |

```
        }
      }
    } ,
```

| reconnectCellId-r16 | CHOICE { | |
|---|---|---|
| nrReconnectCellId-r16 | CGI-Info-Logging-r16, | |
| eutraReconneCtcellId-r16 | CGI-InfoEUTRALogging | |
| } | | OPTIONAL, |
| timeUntilReconnection-r16 | TimeUntilReconnection-r16 | OPTIONAL, |
| reestablishmentcelId-r16 | CGI-Info-Logging-r16 | OPTIONAL, |
| timeConnFailure-r16 | INTEGER (0..1023) | OPTIONAL, |
| timeSinceFailure-r16 | TimeSinceFailure-r16 | |
| connectionFailureTyp-r16 | ENUMERATED {rlf, hof}, | |
| rlf-Cause-r16 | ENUMERATED {t310-Expiry, randomAccessProblem, rlc-MaxNumRetx | |
| | beamFailureRecoveryFailure, lbtFailure-r16 | |
| | bh-rlfRecoveryFailure, t312-expiry-r17, spare1}, | |
| locationInfo-r16 | LocationInfo-r16 | OPTIONAL, |
| noSuitableCellFound-r16 | ENUMERATED {true} | OPTIONAL, |
| ra-InformationCommon-r16 | RA-InformationCommon-r16 | OPTIONAL, |

```
    . . . ,
    [ [
```

| | | |
|---|---|---|
| csi-TSRLMConfigBitmap-v1650 | BIT STRING (SIZE (96) ) | OPTIONAL |

```
    ] ] ,
    [ [
```

| | | |
|---|---|---|
| lastHo-Type-r17 | ENUMERATED {cho ,daps, spare2, spare1} | OPTIONAL, |
| timeConnSourceDAPS-Failure-r17 | TimeConnSourceDAPS-Failure-r17 | OPTIONAL, |
| timesinceCHO-Reconfig-r17 | TimeSinceCHO-Reconfig-r17 | OPTIONAL, |

| | |
|---|---|
| choCellId-r17 | CHOICE { |
| cellGlobalId-r17 | CGI-Info-Logging-r16, |
| pci-arfcn-17 | SEQUENCE |
| physCellId-r17 | PhysCellId; |
| carrierFreq-r17 | ARFCN-ValueNR |

}

| } , | | OPTIONAL |
|---|---|---|
| choCandidateCellList-r17 | ChoCandidateCellList-r17 | OPTIONAL |

```
    ] ] ,
    [ [
```

| | |
|---|---|
| reest-L1L2Candidate-r17 | ENUMERATED {true} OPTIONAL, |
| reest-L1L2meas-r17 | L1L2measList-r18 OPTIONAL, |
| candidates-L1L2Mobility-r17 | Candidates-L1L2Mobility-r18 OPTIONAL, |
| timesinceL1L2Config | TimeSinceL1L2Config-r18 OPTIONAL, |

```
    ] ]
  } ,
```

| | |
|---|---|
| eutra-RLF-Report-r16 | SEQUENCE { |
| failedpCellId EUTRA | CGI-InfoEUTRALogging, |
| measResult-RLE Report EUTRA-r16 | OCTET STRINGS, |

```
    . . .
  }
}
```

| MeasResultList2NR-r16 ::= | SEQUENCE (SIZE (1..maxFreq)) OF MeasResult2NR-r16 | |
|---|---|---|
| MeasResultList2EUTRA-r16 ::= | SEQUENCE (SIZE (1..maxFreq)) OF MeasResult2EUTRA-r16 | |
| MeasResult2NR-r16 ::= | SEQUENCE { | |
| ssbFrequency-r16 | ARFCN-ValueNR | OPTIONAL |
| refFreqcsi-RS-r16 | ARFCN-ValueNR | OPTIONAL, |

| | |
|---|---|
| measResultList-r16 | MeasResultListNR |

}

| Meas ResultListNR ::= | SEQUENCE (SIZE (1..maxCellReport)) OF MeasResultNR | |
|---|---|---|
| MeasResultNR ::= | SEQUENCE { | |
| physCellId | PhysCellId | OPTIONAL, |
| measResult | SEQUENCE { | |
| cellResults | SEQUENCE{ | |
| resultsSSB-Cell | MeasQuantityResults | OPTIONAL, |
| resultsCSI-RS-cell | Meas QuantityResults | OPTIONAL |

},

| rsIndexResults | SEQUENCE{ | |
|---|---|---|
| resultsSSB-Indexes | ResultsPerSSB-IndexList | OPTIONAL, |
| resultsCSI-RS-Indexes | ResultsPerCSI-RS-IndexList | OPTIONAL |

| | |
|---|---|
| } | OPTIONAL |

```
  },
  . . . ,
  [ [
```

| | | |
|---|---|---|
| cgi-Info | CGI-InfoNR | OPTIONAL |

```
  ] ] ,
  [ [
```

| | |
|---|---|
| chocandidate-r17 | ENUMERATED {true} OPTIONAL, |
| choconfig-r17 | SEQUENCE (SIZE (1..2) ) OF CondTriggerconfig-r16 OPTIONAL, |
| triggeredEvent-r17 | SEQUENCE { |
| condFirstEventFullfilled | ENUMERATED {true} OPTIONAL, |
| condSecondEventFullfilled | ENUMERATED {true} OPTIONAL, |
| timeBetweenEvent-r17 | TimeBetweenEvent-r17 OPTIONAL, |
| firstTriggeredEvent | ENUMERATED {condFirstEvent, condSecondEvent} OPTIONAL |

| | |
|---|---|
| } | OPTIONAL |

```
  ] ] ,
  [ [
```

| | | |
|---|---|---|
| candidate-L1L2Flag-117 | ENUMERATED {true} | OPTIONAL |

] ]
}

| | |
|---|---|
| L1L2measList-r18::= | SEQUENCE (SIZE (1..maxNumSSBs) ) OF LIL2meas-r18 |
| L1L2meas-r18 ::= | SEQUENCE { |
| 11-ssb-Index | SSB-Index, |
| 11-ssb-rsrp | RSRP-Range OPTIONAL |
| 11-ssb-sinr | SINR-Range OPTIONAL |

}

| | |
|---|---|
| Candidates-L1L2Mobility-r18::= | SEQUENCE (SIZE (1..maxL1L2Candidate) ) OF L1L2CellID-r18 |
| L1L2CellID-r18 ::= | CHOICE { |
| cellGlobalId-r16 | CGI-Info-Logging-r16, |
| pci-arfon-r16 | SEQUENCE { |
| physCellId-r16 | PhysCellId |
| carrierFreq-r16 | ARFCN-ValueNR |

}

| | |
|---|---|
| candidate-L1L2meas | L1L2measList-r18 |

}
TimesinceL1L2Config-r18::= INTEGER (0..1023)
-- TAG-UEINFORMATIONRESPONSE-STOP
-- ASN1STOP

RLF-Report field descriptions

candidate-L1L2Flag
This field is used to indicate whether the neighbor cell included as part of
measResultListNR was a candidate PCI for L1/L2 inter-cell mobility at the time of
declaring failure.
candidate-L1L2Meas
This field is used to indicate the L1 measurements associated to the SSBs of a cell that
was configured as a candidate PCI for L1/L2 inter-cell mobility at the time of declaring
failure.
candidates-L1L2Mobility
This field is used to indicate the list of candidate PCIs which are part of the candidate list
in L1/L2 inter-cell mobility configuration at the time of declaring failure.
choCandidateCellList
This field is used to indicate the list of candidate target cells for conditional handover
included in condRRCReconfig at the time of connection failure. The field does not include
the candidate target cells included in measResulNeighCells.
choCellId
This field is used to indicate the candidate target cell for conditional handover included in
condRRCReconfig that the UE selected for CHO based recovery while T311 is running.
connectionFailureType
This field is used to indicate whether the connection failure is due to radio link failure or
handover failure.
csi-rsRLMConfigBitmap, csi-rsRLMConfigBitmap-v1650
These fields are used to indicate the CSI-RS indexes configured in the RLM
configurations for the active BWP when the UE declares RLF or HOF. The UE first fills in
the csi-rsRLMConfigBitmap-r16 to indicate the first 96 CSI-RS indexes and then
csi-rsRLMConfigBitmap-v1650 to indicate the latter 96 CSI-RS indexes. The first/leftmost
bit in csi-rsRLMConfigBitmap-r16 corresponds to CSI-RS index 0, the second bit
corresponds to CSI-RS index 1. The first/leftmost bit in csi-rsRLMConfigBitmap-v1650
corresponds to CSI-RS index 96, the second bit corresponds to CSI-RS index 97. These
fields are included only if the RadioLinkMonitoringConfig for the respective BWP is
configured.
c-RNTI
This field indicates the C-RNTI used in the PCell upon detecting radio link failure or the
C-RNTI used in the source PCell upon handover failure.
failedPCellId
This field is used to indicate the PCell in which RLF is detected or the target PCell of the
failed handover. For intra-NR handover nrFailedPCellId is included and for the handover
from NR to EUTRA eutraFailedPCellId is included. The UE sets the ARFCN according to
the frequency band used for transmission/reception when the failure occurred.
failedPCellId-EUTRA
This field is used to indicate the PCell in which RLF is detected or the source PCell of the
failed handover in an E-UTRA RLF report.
I1-ssb-index
This field is used to indicate the ssb index of a PCI that was configured as a candidate
PCI for L1/L2 inter-cell mobility at the time of declaring failure.
I1-ssb-rsrp
This field is used to indicate the L1 RSRP measurement associated to the I1-ssb-index of
a PCI that was configured as a candidate PCI for L1/L2 inter-cell mobility at the time of
declaring failure.
I1-ssb-sinr
This field is used to indicate the L1 SINR measurement associated to the I1-ssb-index of
a PCI that was configured as a candidate PCI for L1/L2 inter-cell mobility at the time of
declaring failure.
measResultListEUTRA
This field refers to the last measurement results taken in the neighboring EUTRA Cells,
when the radio link failure or handover failure happened.
measResultListNR
This field refers to the last measurement results taken in the neighboring NR Cells, when
the radio link failure or handover failure happened or successful handover happened. If
configuration of the conditional handover is available in VarConditionalReconfig when the
radio link failure happened, or if the the last executed RRCReconfiguration message
including reconfigurationWithSync was concerning a conditional handover when the
handover failure or the successful handover happened, the UE uses measResultListNR-r17,
otherwise it uses measResultListNR-r16.
measResultLastServCell
This field refers to the log measurement results taken in the PCell upon detecting radio
link failure or the source PCell upon handover failure.
measResult-RLF-Report-EUTRA
Includes the E-UTRA RLF-Report-r9 IE as specified in TS 36.331 [10].
noSuitableCellFound
This field is set by the UE when the T311 expires.
previousPCellId
This field is used to indicate the source PCell of the last handover (source PCell when the
last executed RRCReconfiguration message including reconfigurationWithSync was
received). For intra-NR handover nrPreviousCell is included and for the handover from
EUTRA to NR eutraPreviousCell is included.
ra-InformationCommon
This field is optionally included when connectionFailureType is set to ‘hof’ or when
connectionFailureType is set to ‘rlf’ and the rlf-Cause equals to ‘randomAccessProblem’ or
‘beamRecoveryFailure’; otherwise this field is absent.
reconnectCellId
This field is used to indicate the cell in which the UE comes back to connected after
connection failure and after failing to perform reestablishment. If the UE comes back to
RRC CONNECTED in an NR cell then nrReconnectCellID is included and if the UE
comes back to RRC CONNECTED in an LTE cell then eutraReconnectCellID is included
reest-L1L2Candidate
This field is used to indicate whether the reestablishment cell was a L1/L2 inter-cell
mobility candidate at the time of declaring radio link failure.
reest-L1L2meas
This field is used to indicate the L1 measurements associated to the reestablishment
cell's SSBs at the time of declaring radio link failure.
eestablishmentCellId
If the UE was not configured with conditionalReconfiguration at the time of
re-establishment attempt, or if the cell selected for the re-establishment attempt is not a
candidate target cell for conditional reconfiguration, this field is used to indicate the cell in
which the re-establishment attempt was made after connection failure.
rlf-Cause
This field is used to indicate the cause of the last radio link failure that was detected. In
case of handover failure information reporting (i.e., the connectionFailureType is set to
‘hof’), the UE is allowed to set this field to any value.
ssbRLMConfigBitmap
This field is used to indicate the SS/PBCH block indexes configured in the RLM
configurations for the active BWP when the UE declares RLF or HOF. The first/leftmost bit
corresponds to SSB index 0, the second bit corresponds to SSB index 1. This field is
included only if the RadioLinkMonitoringConfig for the respective BWP is configured.
timeConnFailure
This field is used to indicate the time elapsed since the last HO execution until connection
failure. Actual value = field value * 100 ms. The maximum value 1023 means 102.3 s or
longer.
timeConnSourceDAPS-Failure
This field is used to indicate the time that elapsed between the last DAPS handover
execution and the radio link failure detected in the source cell while T304 is running.
Value in milliseconds. The maximum value 1023 means 1023 ms or longer.
timeSinceFailure
This field is used to indicate the time that elapsed since the connection (radio link or
handover) failure. Value in seconds. The maximum value 172800 means 172800 s or
longer. In the case of failure(s) (either at source or at target or at both) associated to
DAPS handover, this field indicates the time elapsed since the latest connection (radio
link or handover) failure.
timeSinceCHO-Reconfig
In case of handover failure, this field is used to indicate the time elapsed between the
initiation of the last conditional reconfiguration execution towards the target cell and the
reception of the latest conditional reconfiguration for this target cell. In case of radio link
failure, this field is used to indicate the time elapsed between the radio link failure and the
reception of the latest conditional reconfiguration while connected to the source PCell.
Actual value = field value * 100 ms. The maximum value 1023 means 102.3 s or longer.
timeSinceL1L2Config
This field indicates the time elapsed between the radio link failure and the reception of the
latest L1/L2 mobility configuration while connected to the PCell in which the radio link
failure is experienced.
timeUntilReconnection
This field is used to indicate the time that elapsed between the connection (radio link or
handover) failure and the next time the UE comes to RRC CONNECTED in an NR or
EUTRA cell, after failing to perform reestablishment. Value in seconds. The maximum
value 172800 means 172800 s or longer.

5.3.7.3 Actions following cell selection while T311 is running

Upon selecting a suitable NR cell, the UE may be required to:
1> ensure having valid and up to date essential system information as specified in clause 5.2.2.2;
1> stop timer T311;
1> if T390 is running:
   2> stop timer T390 for all access categories;
   2> perform the actions as specified in 5.3.14.4;
1> if the selected cell is one of the candidate cells for L1/L2 inter-cell mobility:
   2> set the reest-L1L2Candidate in the VarRLF-Report to true;
   2> set the reest-L1L2meas in the VarRLF-Report with the available L1 RSRP, L1 SINR measurements of the SSBs configured for the L1/L2 inter cell mobility measurements;
1> if the cell selection is triggered by detecting radio link failure of the MCG or re-configuration with sync failure of the MCG or mobility from NR failure, and
1> if attemptCondReconfig is configured; and
1> if the selected cell is one of the candidate cells for which the reconfigurationWithSync is included in the masterCellGroup in VarConditionalReconfig:
   2> set the choCellId in the VarRLF-Report to the global cell identity and tracking area code, if available, otherwise to the physical cell identity and carrier frequency of the selected cell;
   2> apply the stored condRRCReconfig associated to the selected cell and perform actions as specified in 5.3.5.3;
NOTE 1: It is left to network implementation to how to avoid keystream reuse in case of CHO based recovery after a failed handover without key change.
1> else:
   2> if UE is configured with conditionalReconfiguration:
      3> reset MAC;
      3> release spCellConfig, if configured;
      3> release the MCG SCell(s), if configured;
      3> release delayBudgetReportingConfig, if configured and stop timer T342, if running;
      3> release overheatingAssistanceConfig, if configured and stop timer T345, if running;
      3> if MR-DC is configured:
         4> perform MR-DC release, as specified in clause 5.3.5.10;
      3> release idc-AssistanceConfig, if configured;
      3> release btNameList, if configured;
      3> release wlanNameList, if configured;
      3> release sensorNameList, if configured;
      3> release drx-PreferenceConfig for the MCG, if configured and stop timer T346a associated with the MCG, if running;
      3> release maxBW-PreferenceConfig for the MCG, if configured and stop timer T346b associated with the MCG, if running;
      3> release maxCC-PreferenceConfig for the MCG, if configured and stop timer T346c associated with the MCG, if running;
      3> release maxMIMO-LayerPreferenceConfig for the MCG, if configured and stop timer T346d associated with the MCG, if running;
      3> release minSchedulingOffsetPreferenceConfig for the MCG, if configured and stop timer T346e associated with the MCG, if running;
      3> release rlm-RelaxationReportingConfig for the MCG, if configured and stop timer T346j associated with the MCG, if running;
      3> release bfd-RelaxationReportingConfig for the MCG, if configured and stop timer T346k associated with the MCG, if running;
      3> release releasePreferenceConfig, if configured and stop timer T346f, if running; 3> release onDemandSIB-Request if configured, and stop timer T350, if running;
      3> release referenceTimePreferenceReporting, if configured;
      3> release sl-AssistanceConfigNR, if configured;
      3> release obtainCommonLocation, if configured;
      3> release scg-DeactivationPreferenceConfig, if configured, and stop timer T346i, if running;
      3> suspend all RBs, except SRB0;
   2> remove all the entries within VarConditionalReconfig, if any;
   2> for each measId, if the associated reportConfig has a reportType set to condTriggerConfig:
      3> for the associated reportConfigId:
         4> remove the entry with the matching reportConfigId from the reportConfigList within the VarMeasConfig;
      3> if the associated measObjectId is only associated to a reportConfig with reportType set to condTriggerConfig:
         4> remove the entry with the matching measObjectId from the measObjectList within the VarMeasConfig;
      3> remove the entry with the matching measId from the measIdList within the VarMeasConfig;
   2> start timer T301;
   2> apply the default L1 parameter values as specified in corresponding physical layer specifications except for the parameters for which values are provided in SIB1;
   2> apply the default MAC Cell Group configuration as specified in 9.2.2;
   2> apply the CCCH configuration as specified in 9.1.1.2;
   2> apply the timeAlignmentTimerCommon included in SIB1;
   2> initiate transmission of the RRCReestablishmentRequest message in accordance with 5.3.7.4;
NOTE 2: This procedure applies also if the UE returns to the source PCell.

Upon selecting an inter-RAT cell, the UE shall:
1> perform the actions upon going to RRC_IDLE as specified in 5.3.11, with release cause ‘RRC connection failure’.

### 5.3.7.4 Actions Related to Transmission of RRCReestablishmentRequest Message

The UE may be required to set the contents of RRCReestablishmentRequest message as follows:
1> if the procedure was initiated due to radio link failure as specified in 5.3.10.3 or reconfiguration with sync failure as specified in 5.3.5.8.3:
   2> set the reestablishmentCellId in the VarRLF-Report to the global cell identity of the selected cell;
   2> if the selected cell is one of the candidate cells for L1/L2 inter-cell mobility:
      3> set the reest-L1L2Candidate in the VarRLF-Report to true;
      3> set the reest-L1L2meas in the VarRLF-Report with the available L1 RSRP, L1 SINR measurements of the SSBs configured for the L1/L2 inter cell mobility measurements;
1> set the ue-Identity as follows:
   2> set the c-RNTI to the C-RNTI used in the source PCell (reconfiguration with sync or mobility from NR failure) or used in the PCell in which the trigger for the re-establishment occurred (other cases);
   2> set the physCellId to the physical cell identity of the source PCell (reconfiguration with sync or mobility from NR failure) or of the PCell in which the trigger for the re-establishment occurred (other cases);
   2> set the shortMAC-I to the 16 least significant bits of the MAC-I calculated:
      3> over the ASN.1 encoded as per clause 8 (i.e., a multiple of 8 bits) VarShortMAC-Input;
      3> with the K_{RRCint} key and integrity protection algorithm that was used in the source PCell (reconfiguration with sync or mobility from NR failure) or of the PCell in which the trigger for the re-establishment occurred (other cases); and
      3> with all input bits for COUNT, BEARER and DIRECTION set to binary ones;
1> set the reestablishmentCause as follows:
   2> if the re-establishment procedure was initiated due to reconfiguration failure as specified in 5.3.5.8.2:
      3> set the reestablishmentCause to the value reconfigurationFailure;
   2> else if the re-establishment procedure was initiated due to reconfiguration with sync failure as specified in 5.3.5.8.3 (intra-NR handover failure) or 5.4.3.5 (inter-RAT mobility from NR failure):
      3> set the reestablishmentCause to the value handoverFailure;
   2> else:
      3> set the reestablishmentCause to the value otherFailure;
1> re-establish PDCP for SRB1;
1> if the UE is connected with a L2 U2N Relay UE via PC5-RRC connection (i.e. the UE is a L2 U2N Remote UE):
   2> apply the default configuration of SL-RLC1 as defined in 9.2.4 for SRB1;
   2> apply the default configuration of PDCP defined in 9.2.1 for SRB1;
1> else:
   2> re-establish RLC for SRB1;
   2> apply the default configuration defined in 9.2.1 for SRB1;
1> configure lower layers to suspend integrity protection and ciphering for SRB1;
NOTE: Ciphering is not applied for the subsequent RRCReestablishment message used to resume the connection. An integrity check is performed by lower layers, but merely upon request from RRC.
1> resume SRB1;
1> submit the RRCReestablishmentRequest message to lower layers for transmission.

### 5.3.10.5 RLF Report Content Determination

The UE may be required to determine the content in the VarRLF-Report as follows:
1> clear the information included in VarRLF-Report, if any;
1> set the plmn-IdentityList to include the list of EPLMNs stored by the UE (i.e. includes the RPLMN);
1> if the UE was configured with L1/L2 inter-cell mobility configuration at the time of declaring failure:
   2> set L1L2CellID to the global cell identity, if available, otherwise to the physical cell identity and the carrier frequency of each of the candidate cells as configured in the L1/L2 inter-cell mobility configuration;
   2> for each of the candidate cell included in the L1L2CellID include:
      3> for each of the SSBs configured in the L1/L2 inter-cell mobility configuration, include the available SSB index, L1 RSRP and L1 SINR;
1> if the failure is detected due to reconfiguration with sync failure as described in 5.3.5.8.3, set the fields in VarRLF-report as follows:
   2> set the connectionFailureType to hof,
   . . .
1> else if the failure is detected due to Mobility from NR failure as described in 5.4.3.5, set the fields in VarRLF-report as follows:
   2> set the connectionFailureType to hof,
   . . .
1> else if the failure is detected due to radio link failure as described in 5.3.10.3, set the fields in VarRLF-report as follows:
   2> set the connectionFailureType to rlf;
   2> set the rlf-Cause to the trigger for detecting radio link failure in accordance with clause 5.3.10.4;
   2> set the nrFailedPCellId in failedPCellId to the global cell identity and the tracking area code, if available, and otherwise to the physical cell identity and carrier frequency of the PCell where radio link failure is detected;
   2> if the UE had received an RRCReconfiguration message including the reconfigurationWithSync was received before the connection:
      3> if the last RRCReconfiguration message including the reconfigurationWithSync concerned an intra NR handover:
         4> include the nrPreviousCell in previousPCellId and set it to the global cell identity and the tracking area code of the PCell where the last executed RRCReconfiguration message including reconfigurationWithSync was received;
         4> if the last executed RRCReconfiguration message including reconfigurationWithSync was concerning a DAPS handover:
         5> set lastHO-Type to daps,
         4> else if the last executed RRCReconfiguration message including reconfigurationWithSync was concerning a conditional handover:
         5> set lastHO-Type to cho;
         4> set the timeConnFailure to the elapsed time since the execution of the last RRCReconfiguration message including the reconfigurationWithSync;
      3> else if the last RRCReconfiguration message including the reconfigurationWithSync concerned a handover to NR from E-UTRA and if the UE supports Radio Link Failure Report for Inter-RAT MRO EUTRA:
         4> include the eutraPreviousCell in previousPCellId and set it to the global cell identity and the tracking area code of the E-UTRA PCell where the last RRCReconfiguration message including reconfigurationWithSync was received embedded in E-UTRA RRC message MobilityFromEUTRACommand message as specified in TS 36.331 clause 5.4.3.3;
         4> set the timeConnFailure to the elapsed time since reception of the last RRCReconfiguration message including the reconfigurationWithSync embedded in E-UTRA RRC message MobilityFromEUTRACommand message as specified in TS 36.331 clause 5.4.3.3;
      3> if configuration of the conditional handover is available in VarConditionalReconfig at the moment of radio link failure:
         3> set choCandidateCellList to include the global cell identity and tracking area code of all the candidate target cells for conditional handover included in condRRCReconfig within VarConditionalReconfig at the time of radio link failure, excluding the candidate target cells included in measResulNeighCells;
   2> if configuration of the conditional handover is available in VarConditionalReconfig at the moment of declaring the radio link failure:
      3> set timeSinceCHO-Reconfig to the time elapsed between the detection of the radio link failure, and the reception, in the source PCell, of the last conditionalReconfiguration including the condRRCReconfig message;
   2> if configuration of the L1/L2 mobility is available at the moment of declaring the radio link failure:
      3> set timeSinceL1L2Config to the time elapsed between the detection of the radio link failure, and the reception in the PCell of the last L1/L2 mobility configuration;
1> if connectionFailureType is rlf and the rlf-Cause is set to randomAccessProblem or beamFailureRecoveryFailure; or
1> if connectionFailureType is hof and if the failed handover is an intra-RAT handover:
   2> set the ra-InformationCommon to include the random-access related information as described in clause 5.7.10.5;
1> if available, set the locationInfo as in 5.3.3.7.

The UE may discard the radio link failure information or handover failure information, i.e. release the UE variable VarRLF-Report, 48 hours after the radio link failure/handover failure is detected.
NOTE 2: In this clause, the term ‘handover failure’ has been used to refer to ‘reconfiguration with sync failure’.

In yet other embodiments, for each neighbor cell included in the RLF report, the UE may also include the corresponding L1/L2 inter-cell mobility related measurements if that neighbor cell happens to be a candidate for the L1/L2 inter-cell mobility, e.g., candidate-L1L2meas in the example implementation below.

By sending the stored one or more indications to the third network node 113 in this Action 306, the wireless device 130 may enable the network, e.g., the third network node 113, to identify, based on the additional contents of the report, e.g., RLF report, as proposed in embodiments herein, whether the reestablishment cell, e.g., the first cell 123, was part of the L1/L2 inter-cell mobility configuration or not. The wireless device 130 may thereby enable the network, e.g., the third network node 113 to know whether the problem may lie in the L1/L2 inter-cell mobility triggering at the DU or the L1/L2 inter-cell mobility candidate selection or the L3 mobility configurations.

If the reestablishment cell was part of the candidate list in L1/L2 inter-cell mobility, then the network, e.g., via the third network node 113, may be able to fine tune the triggering of the L1/L2 inter-cell mobility amongst the candidates. For example, a gNB-DU may be able to optimize the L1/L2 inter-cell mobility parameters.

If the reestablishment cell was not part of the candidate list in L1/L2 inter-cell mobility but the cell in which the wireless device 130 declared the failure, e.g., RLF, and the reestablishment cell may be configured as L1/L2 inter-cell mobility candidates, then the network, e.g., the third network node 113, may fine tune the configuration of the candidates for the L1/L2 inter-cell mobility. For example, the CU-CP and the DU may optimize the candidate selection algorithms. In addition, based on the L1/L2 provided measurements, the DU may find the optimal triggering thresholds for the L1/L2 mobility from the failed cell toward the re-establishment cell.

If the reestablishment cell was not part of the candidate list in L1/L2 inter-cell mobility and the cell in which the wireless device 130 declared the failure, e.g., RLF, and the reestablishment cell may not be configured as L1/L2 inter-cell mobility candidates, then the network, e.g., the third network node 113, may fine tune the L3 mobility parameters. For example, the CU-CP may optimize the handover parameters.

### Action 307

In this Action 307, the wireless device 130 may receive an updated inter-cell mobility procedure configuration. The mobility procedure may be, e.g., L1/L2 inter-cell mobility procedure. The receiving in this Action 307 may be from the third network node 113.

The receiving in this Action 307 may be, e.g., based on the sent one or more indications.

The updated configuration may comprise adapted one or more procedures e.g., at least one from: selection of candidate cells, triggering thresholds for the mobility procedure, and L3 mobility parameters.

By receiving the updated inter-cell mobility procedure configuration in this Action 307, the wireless device 130 may be enabled to perform optimized mobility procedures, with reduced latency, shorter interruptions in communications, and more efficient usage of resources in the wireless communications network 100.

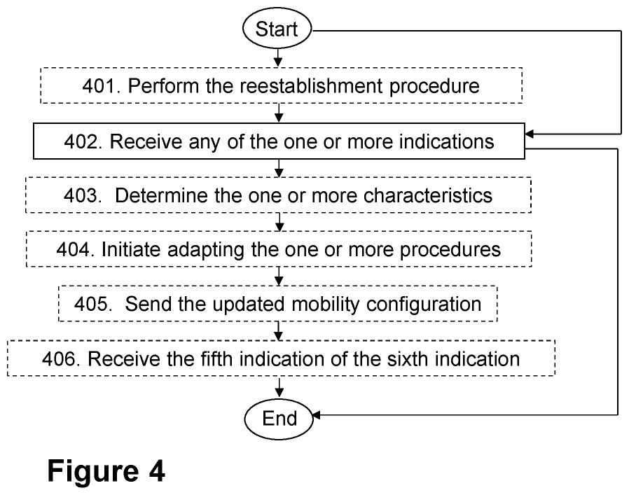

Embodiments of a method, performed by a network node, such as the third network node 113, will now be described with reference to the flowchart depicted in FIG. 4. The method may be understood to be for handling the re-establishment information after the failure in the mobility procedure, that is the failure by the wireless device 130, e.g., from the first network node 111 to the second network node 112. The network node 113, e.g., the third network node 113, operates in a wireless communications network, such as the wireless communications network 100. The method may be understood to be computer-implemented.

In some embodiments, the wireless communications network 100 may support New Radio (NR).

Several embodiments are comprised herein. The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third network node 113, also referred to simply as the network node 113, is depicted in FIG. 4. In FIG. 4, optional actions in some embodiments may be represented with dashed lines. In some embodiments, the actions may be performed in a different order than that depicted FIG. 4.

The detailed description of some of the following corresponds to the same references provided above, in relation to the actions described for the wireless device 130 and will thus not be repeated here to simplify the description. For example, the failure may be, e.g., a radio link failure. A mobility procedure may also be referred to herein simply as mobility.

### Action 401

In this Action 401, the network node 113 may perform the reestablishment procedure or reconnection procedure with the wireless device 130.

In some embodiments, one of the following options may apply. According to a first option, the reestablishment procedure may be performed after the wireless device 130 may have gone to idle mode after the failed mobility procedure. According to a second option, the reestablishment procedure may have failed and the wireless device 130 may reconnect to the network node 113, that is, the third network node 113.

### Action 402

In this Action 402, the network node 113 receives, from the wireless device 130, the one or more indications, e.g., the subset of the one or more indications. The one or more indications may indicate the failed mobility procedure. That is, the one or more indications indicate the failure. The one or more indications comprise at least the first indication.

The first indication indicates whether the first cell 123 selected by the wireless device 130 for the reestablishment procedure triggered by the failure, was a candidate cell in the inter-cell mobility configuration received by the wireless device 130 in the previous indication to perform the L1/L2 mobility procedure. That is, the mobility procedure, as described above, that failed.

The failure may be considered as a failed mobility procedure as described above.

The receiving in this Action 402 may be performed, e.g., via the first link 141.

The previous indication may have been received, e.g., from the first network node 111, from the second network node 112, or from another network node operating in the wireless communications network 100.

In some embodiments, at least one of the following options may apply: a) the failure may be the mobility procedure, b) the failure may be one of: the radio link failure and the handover failure, c) the mobility, e.g., the mobility procedure, may be an L1/L2 inter-cell mobility, d) the one or more indications may be received in the report, e.g., the RLF report, e) the one or more indications may be received in the UEInformationResponse message, and f) the inter-cell mobility configuration may be the L1/L2 inter-cell mobility configuration.

In some embodiments, the one or more indications may further comprise at least one of the following: a) the second indication, wherein the second indication may indicate the one or more candidate cells 125 as configured in the inter-cell mobility, e.g., L1/L2 inter-cell mobility, configuration, b) the third indication, wherein the third indication may indicate the time elapsed between the first time of reception of the inter-cell mobility, e.g., L1/L2 inter-cell mobility, configuration, and the second time when the failure, e.g., radio link failure, was declared, c) the third indication, further indicating the third time elapsed between the fourth time of reception of the last inter-cell mobility, e.g., L1/L2 inter-cell mobility, configuration, and the second time when the failure, e.g., radio link failure, was declared, and d) the fourth indication, wherein the fourth indication may indicate at least one of: i) the first location information at the fourth time, and ii) the second location information at the second time.

In some embodiments, at least one of the following may apply: a) the first indication may be indicated by a one-bit flag, b) the first indication may be indicated by the reest-L1L2Candidate IE, c) the first indication may further indicate the additional L1/L2 mobility related measurements, d) the first indication with the additional L1/L2 mobility related measurements may be indicated by the reest-L1L2meas IE, e) the first indication with the additional L1/L2 mobility related measurements may be indicated by the 38 reconnect-L1L2meas, f) the second indication may be indicated by the a candidates-L1L2Mobility IE, g) the second indication may be indicated by the candidate-L1L2flag flag, h) the second indication may further indicate additional L1/L2 mobility related measurements, i) the second indication with the additional L1/L2 mobility related measurements may be indicated by the candidate-L1L2meas IE, j) the third indication may be indicated by the another IE, and k) the fourth indication may be indicated by the yet another IE.

The one or more Indications may be received after having performed the reestablishment procedure.

In some embodiments, the method may further comprise one or more of the following actions 403, 404, 405, 406.

In some particular embodiments, the method may further comprise one or more of the following actions 403, 404, 405, 406, e.g., wherein the reestablishment procedure may have failed and the wireless device 130 may reconnect to the network node 113.

### Action 403

In this Action 403, network node 113 may determine one or more characteristics of the inter-cell mobility configuration. The determining in this Action 403 may be, based on the received one or more indications, e.g., the subset.

The determined one or more characteristics of the inter-cell mobility configuration may be e.g., selected from: i) whether the first cell 123 selected by the wireless device 130 for the reestablishment procedure was a candidate cell in the inter-cell mobility configuration, ii) measurement results of one or more candidate cells 125 as configured in the inter-cell mobility, e.g., L1/L2 inter-cell mobility, configuration, and iii) how long the wireless device 130 has been configured with the in the inter-cell mobility, e.g., L1/L2 inter-cell mobility, configuration before the failure occurred, that is before the radio link failure occurred.

### Action 404

In this Action 404, the network node 113 may initiate adapting one or more procedures of the inter-cell mobility, e.g., L1/L2 inter-cell mobility, configuration.

Initiating may be understood as starting, facilitating, enabling, triggering or similar.

In some examples, adapting of the one or more procedures of the inter-cell mobility, e.g., L1/L2 inter-cell mobility, configuration, may be e.g., at least one from: selection of candidate cells, triggering thresholds for the mobility procedure, and L3 mobility parameters.

The initiating in this Action 404 may be e.g., based on a result of the determination.

### Action 405

In this Action 405, the network node 113 may send an updated inter-cell mobility, e.g., L1/L2 inter-cell mobility, configuration. That is, the inter-cell mobility procedure configuration described in Action 307.

The updated inter-cell mobility, e.g., L1/L2 inter-cell mobility, configuration may comprise the adapted one or more procedures.

The sending of the updated inter-cell mobility, e.g., L1/L2 inter-cell mobility, configuration in this Action 405 may be based on the adaptation initiated in Action 404.

In some embodiments, at least one of the following options may apply. According to a first option a) with the proviso that the first cell 123 was not a candidate cell in the inter-cell mobility configuration, the adapting may comprise adding the first cell 123 to a list of candidate cells in the inter-cell mobility configuration, e.g., for devices connected to a cell, e.g., a PCell, in which the failed mobility procedure was detected. In one example, if the reestablished cell was not configured as candidate cell for L1/L2 mobility, the network node 113 may include the reestablished cell in the list of candidate cells for UEs connected to the PCell in which the radio link failure was detected.

According to a second option b), with the proviso that the measurement results indicate that a first candidate cell 126 has better measurement results, the adapting may comprise triggering a mobility procedure towards the first candidate cell 126. In another example, the network node 113 may derive from the RLF-Report the measurement results of the candidate L1/L2 cells, on the basis of that it may earlier trigger a L1/L2 mobility towards one of those candidate L1/L2 cells having better measurement results.

According to a third option c), with the proviso that the measurement results indicate that the first candidate cell 126 has poor measurement results, the adapting may comprise removing the first candidate cell 126 from the one or more candidate cells 125. In another example, the network node 113 may derive from the report, e.g., the RLF-Report, the measurement results of the candidate L1/L2 cells, on the basis of that it may also remove those candidate cells which may have unsatisfactory measurement results from the list of configured candidate cells for L1/L2 mobility.

According to a fourth option d), with the proviso that the measurement results indicate that a first neighbor cell 127 has good measurement results, and the first neighbor cell 127 is not a candidate cell in the inter-cell mobility configuration, the adapting may comprise adding the first neighbor cell 127 to the list of candidate cells in the inter-cell mobility configuration. In another example, the network node 113 may derive from the report, e.g., the RLF-Report, the measurement results of the candidate L1/L2 cells, on the basis of that it may also include based on such measurement results, cells which may have good measurement results but that may not be currently configured as candidate cells for L1/L2 mobility in the configured list of candidate cells for L1/L2 mobility for UE connected to the PCell in which the failure occurred.

In some other examples, the network node 113, in Action 403, may derive for how long the wireless device 130 may have been configured for L1/L2 mobility before the failure occurred. If the time is deemed short, then the network node 113, in Action 404 and/or Action 405, may configure the L1/L2 mobility configuration a bit earlier. That may be understood to be because, if the failure is experienced by the wireless device 130 soon after the L1/L2 mobility configuration, the network node 113 may not have had time to collect enough L1/L2 measurements to trigger the L1/L2 mobility. On the other hand, if the time is deemed too long in Action 403, the network node 113 may, in Action 404 and/or Action 405, configure the L1/L2 mobility configuration a bit later, since the L1/L2 mobility configuration may cost extra UE resources, e.g., memory resources, energy, and potentially radio resources, if the L1/L2 mobility configuration also implies a new set of measurements and signalling reports to the network node 113. Also, a too early L1/L2 mobility configuration may cost extra resources at the network node 113 side, especially if target cells potentially belonging to different nodes may need to be prepared in advance for a potential handover.

### Action 406

Action 406 may be performed in embodiments wherein the reestablishment procedure may have failed and the wireless device 130 may reconnect to the network node 113. In this Action 406, the network node 113 may receive at least one of the fifth indication and the sixth indication.

The receiving in this Action 406 may be, from the wireless device 130, e.g., after reconnection.

The fifth indication may indicate whether the second cell 124 selected by the wireless device 130 for the reconnection procedure triggered by the failed reestablishment procedure, was a candidate cell in the inter-cell mobility configuration received in the previous indication. The sixth indication may indicate the time elapsed between the first time of reception of the inter-cell mobility, e.g., L1/L2 inter-cell mobility, configuration, and the fifth time of the reconnection upon selection of the second cell 124.

In some embodiments, the fifth indication may be indicated by the reConnect-L1L2Candidate IE.

As an overview of the foregoing, examples of embodiments disclosed herein may relate to a wireless device, a network node, and methods performed thereby for handling re-establishment information after a failure in a mobility procedure. The failure may be a radio link failure.

As a summarized overview of the foregoing, examples of embodiments disclosed herein may relate to a method performed by the wireless device 130, e.g., a UE, the method comprising: a) receiving a L1/L2 inter-cell mobility configuration from the first network node 111, b) declaring radio link failure, c) storing a first set of information associated to the radio link failure in a first report, wherein the first set of information may include one or more of: i) an indication indicating whether the cell, which may be selected for reestablishment procedure, was a candidate cell in L1/L2 inter-cell mobility configuration, ii) an indication indicating the candidate cells as configured in the L1/L2 inter-cell mobility configuration, iii) an indication indicating the time elapsed since the reception of the configuration of the L1/L2 inter-cell mobility and the radio link failure, iv) in an example, the indication may indicate the time elapsed since the reception of the last L1/L2 mobility configuration, and the radio link failure; and v) an indication indicating the location information at the time of reception of the last L1/L2 mobility configuration, beside the location information at the time of the radio link failure; and d) Performing a reestablishment procedure, possibly to the cell which was a candidate in L1/L2 inter-cell mobility configuration, or going in IDLE mode if no suitable cell found.

The above information and indication collected by the wireless device 130 concerning the re-establishment cell may be also appliable to the scenario in which the wireless device 130 may fail to perform the re-establishment and hence reconnect to another cell after transition to the RRC_IDLE mode.

Certain embodiments disclosed herein may provide one or more of the following technical advantage(s), which may be summarized as follows.

Embodiments herein, may be understood to enable the network to identify, based on the additional contents of the RLF report as proposed in embodiments herein, whether the reestablishment cell was part of the L1/L2 inter-cell mobility configuration or not.

If the reestablishment cell was part of the candidate list in L1/L2 inter-cell mobility, then the network may be able to fine tune the triggering of the L1/L2 inter-cell mobility amongst the candidates. For example, a gNB-DU may be able to optimize the L1/L2 inter-cell mobility parameters.

If the reestablishment cell was not part of the candidate list in L1/L2 inter-cell mobility but the cell in which the wireless device 130 declared RLF and the reestablishment cell may be configured as L1/L2 inter-cell mobility candidates, then the network may fine tune the configuration of the candidates for the L1/L2 inter-cell mobility. For example, the CU-CP and the DU may optimize the candidate selection algorithms. In addition, based on the L1/L2 provided measurements, the DU may find the optimal triggering thresholds for the L1/L2 mobility from the failed cell toward the re-establishment cell.

If the reestablishment cell was not part of the candidate list in L1/L2 inter-cell mobility and the cell in which the wireless device 130 declared RLF and the reestablishment cell may not be configured as L1/L2 inter-cell mobility candidates, then the network may fine tune the L3 mobility parameters. For example, the CU-CP may optimize the handover parameters.

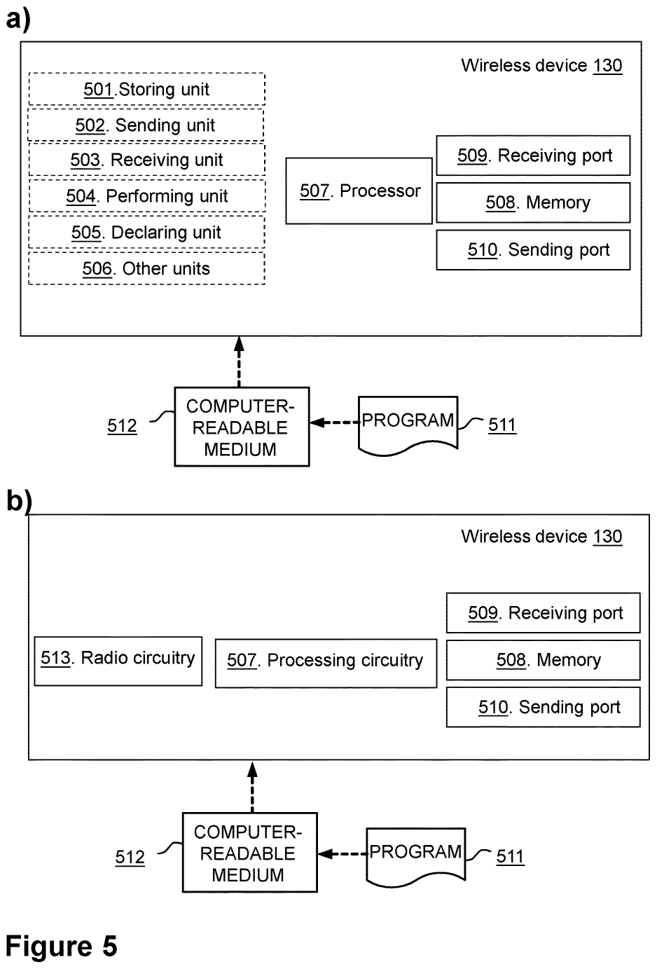

FIG. 5 depicts two different examples in panels a) and b), respectively, of the arrangement that the wireless device 130 may comprise to perform the method actions described above in relation to FIG. 3. In some embodiments, the wireless device 130 may comprise the following arrangement depicted in FIG. 5a. The wireless device 130 may be understood to be for handling the re-establishment information after the failure. The wireless device 130 may be configured to operate in the wireless communications network 100.

In some embodiments, the wireless communications network 100 may be configured to support New Radio (NR).

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the one or more indications may be configured to be sent in a report, which may be, e.g., an RLF report.

In FIG. 5, optional units are indicated with dashed boxes.

The wireless device 130 is configured to perform the storing/logging/recording of Action 304, e.g., by means of a storing unit 501 within the wireless device 130, configured to store, responsive to the declared failure, the one or more indications configured to indicate the failure. The one or more indications are configured to comprise at least the first indication configured to indicate whether the first cell 123 configured to be selected by the wireless device 130 for the reestablishment procedure configured to be triggered by the failure, was a candidate cell in an inter-cell mobility configuration configured to be received in a previous indication to perform the L1/L2 mobility procedure.

In some embodiments, at least one of the following may apply: a) the failure may be configured to be the mobility procedure, b) the failure may be configured to be one of: the radio link failure and the handover failure, c) the mobility procedure may be configured to be the L1/L2 inter-cell mobility, d) the one or more indications may be configured to be sent in the report, e) the one or more indications may be configured to be sent in the UEInformationResponse message, and f) the inter-cell mobility configuration may be configured to be the L1/L2 inter-cell mobility configuration.

In some embodiments, the one or more indications may be configured to further comprise at least one of: a) the second indication configured to indicate the one or more candidate cells 125 as configured in the inter-cell mobility configuration, b) the third indication configured to indicate the time elapsed between the first time of reception of the inter-cell mobility configuration, and the second time when the failure was declared, c) the third indication, further configured to indicate the third time elapsed between the fourth time of reception of the last inter-cell mobility configuration including, as candidate cell, the first cell 123 configured to be selected for the reestablishment procedure, and the second time when the failure was declared, and d) the fourth indication configured to indicate at least one of: i) the first location information at the fourth time, and ii) the second location information at the second time.

In some embodiments, at least one of the following may apply: a) the first indication may be configured to be indicated by a one-bit flag, b) the first indication may be configured to be indicated by the reest-L1L2Candidate IE, c) the first indication may be further configured to indicate the additional L1/L2 mobility related measurements, d) the first indication with the additional L1/L2 mobility related measurements may be configured to be indicated by the reest-L1L2meas IE, e) the first indication with the additional L1/L2 mobility related measurements may be configured to be indicated by the reConnect-L1L2meas, f) the second indication may be configured to be indicated by the candidates-L1L2Mobility IE, g) the second indication may be configured to be indicated by the candidate-L1L2flag flag, h) the second indication may be configured to further indicate the additional L1/L2 mobility related measurements, i) the second indication with the additional L1/L2 mobility related measurements may be configured to be indicated by the candidate-L1L2meas IE, j) the third indication may be configured to be indicated by the another IE, and k) the fourth indication may be configured to be indicated by yet the another IE.

In some embodiments, the wireless device 130 may be further configured to one or more of the following.

The wireless device 130 may be configured to perform the sending of Action 306, e.g., by means of a sending unit 502 within the wireless device, configured to, send any of the one or more indications configured to be stored to the network node 113 configured to operate in the wireless communications network 100.

The wireless device 130 may be configured to perform the receiving in Action 301, e.g., by means of a receiving unit 503 within the wireless device 130, configured to receive the previous indication from the first network node 111.

The wireless device 130 may be configured to perform the performing in Action 302, e.g., by means of a performing unit 504, within the wireless device 130, configured to perform, responsive to the previous indication configured to be received, the L1/L2 inter-cell mobility procedure, from the first network node 111 to the second network node 112 configured to operate in the wireless communications network 100.

The wireless device 130 may be configured to perform the declaring of Action 303, e.g., by means of a declaring unit 505 within the wireless device 130, configured to declare the failure. e.g., radio link failure.

The wireless device 130 may be configured to perform the performing in Action 305, e.g., by means of the performing unit 504, within the wireless device 130, configured to perform the reestablishment procedure or reconnection procedure to the third network node 113 configured to operate in the wireless communications network 100.

The wireless device 130 may be configured to perform the receiving in Action 307, e.g., by means of the receiving unit 503, within the wireless device 130, configured to receive, based on the one or more indications configured to be sent, the updated inter-cell mobility procedure configuration from the network node 113. The updated configuration may be configured to comprise the adapted one or more procedures.

In some embodiments, one of the following may apply: a) the wireless device 130 may be configured to perform the reestablishment procedure after going to idle mode or after the radio link failure, and b) the wireless device 130 may be configured to reconnect to the network node 113 after the reestablishment procedure may fail.

In some embodiments, the wireless device 130 may be configured to reconnect to the network node 113 after the reestablishment procedure may fail and, and the storing may be further configured to comprise storing at least one of: a) the fifth indication configured to indicate whether the second cell 124 configured to be selected by the wireless device 130 for the reconnection procedure configured to be triggered by the failed reestablishment procedure, was a candidate cell in the inter-cell mobility configuration configured to be received in the previous indication, and b) the sixth indication configured to indicate the time elapsed between the first time of reception of the inter-cell mobility configuration, and the fifth time of the reconnection upon selection of the second cell 124.

In some embodiments, the fifth indication may be configured to be indicated by the reConnect-L1L2Candidate IE.

Other units 506 may be comprised in the wireless device 130.

The embodiments herein in the wireless device 130 may be implemented through one or more processors, such as a processor 507 in the wireless device 130 depicted in FIG. 5a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The wireless device 130 may further comprise a memory 508 comprising one or more memory units. The memory 508 is arranged to be used to store obtained information, store data, configurations, schedulings, and applications etc. to perform the methods herein when being executed in the wireless device 130.

In some embodiments, the wireless device 130 may receive information from, e.g., the first network node 111, the second network node 112, the third network node 113, the network node 113, the source cell 121, the target cell 122, the first cell 123, the second cell 124, the one or more candidate cells 125, the first candidate cell 126, the first neighbor cell 127 and/or another cell, network node or node, through a receiving port 509. In some embodiments, the receiving port 509 may be, for example, connected to one or more antennas in wireless device 130. In other embodiments, the wireless device 130 may receive information from another structure in the wireless communications network 100 through the receiving port 509. Since the receiving port 509 may be in communication with the processor 507, the receiving port 509 may then send the received information to the processor 507. The receiving port 509 may also be configured to receive other information.

The processor 507 in the wireless device 130 may be further configured to transmit or send information to e.g., the first network node 111, the second network node 112, the third network node 113, the network node 113, the source cell 121, the target cell 122, the first cell 123, the second cell 124, the one or more candidate cells 125, the first candidate cell 126, the first neighbor cell 127, another cell, network node or node, or another structure in the wireless communications network 100, through a sending port 510, which may be in communication with the processor 507, and the memory 508.

Those skilled in the art will also appreciate that the different units 501-506 described above may refer to a combination of analog and digital modules, and/or one or more processors configured with software and/or firmware, e.g., stored in memory, that, when executed by the one or more processors such as the processor 507, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 501-506 described above may be implemented as one or more applications running on one or more processors such as the processor 507.

Thus, the methods according to the embodiments described herein for the wireless device 130 may be respectively implemented by means of a computer program 511 product, comprising instructions, i.e., software code portions, which, when executed on at least one processor 507, cause the at least one processor 507 to carry out the actions described herein, as performed by the wireless device 130. The computer program 511 product may be stored on a computer-readable storage medium 512. The computer-readable storage medium 512, having stored thereon the computer program 511, may comprise instructions which, when executed on at least one processor 507, cause the at least one processor 507 to carry out the actions described herein, as performed by the wireless device 130. In some embodiments, the computer-readable storage medium 512 may be a non-transitory computer-readable storage medium, such as a CD ROM disc, or a memory stick. In other embodiments, the computer program 511 product may be stored on a carrier containing the computer program 511 just described, wherein the carrier is one of an electronic signal, optical signal, radio signal, or the computer-readable storage medium 512, as described above.

The wireless device 130 may comprise a communication interface configured to facilitate communications between the wireless device 130 and other nodes or devices, e.g., the first network node 111, the second network node 112, the third network node 113, the network node 113, the source cell 121, the target cell 122, the first cell 123, the second cell 124, the one or more candidate cells 125, the first candidate cell 126, the first neighbor cell 127, another cell, network node or node, or another structure in the wireless communications network 100. The interface may, for example, include a transceiver configured to transmit and receive radio signals over an air interface in accordance with a suitable standard.

In other embodiments, the wireless device 130 may comprise the following arrangement depicted in FIG. 5b. The wireless device 130 may comprise a processing circuitry 507, e.g., one or more processors such as the processor 507, in the wireless device 130 and the memory 508. The wireless device 130 may also comprise a radio circuitry 513, which may comprise e.g., the receiving port 509 and the sending port 510. The processing circuitry 513 may be configured to, or operable to, perform the method actions according to FIG. 3, in a similar manner as that described in relation to FIG. 5a. The radio circuitry 513 may be configured to set up and maintain at least a wireless connection with the first network node 111, the second network node 112, the third network node 113, the network node 113, the source cell 121, the target cell 122, the first cell 123, the second cell 124, the one or more candidate cells 125, the first candidate cell 126, the first neighbor cell 127, another cell, network node or node, or another structure in the wireless communications network 100. Circuitry may be understood herein as a hardware component.

Hence, embodiments herein also relate to the wireless device 130 comprising the processing circuitry 507 and the memory 508, said memory 508 containing instructions executable by said processing circuitry 507, whereby the wireless device 130 is operative to perform the actions described herein in relation to the wireless device 130, e.g., in FIG. 3.

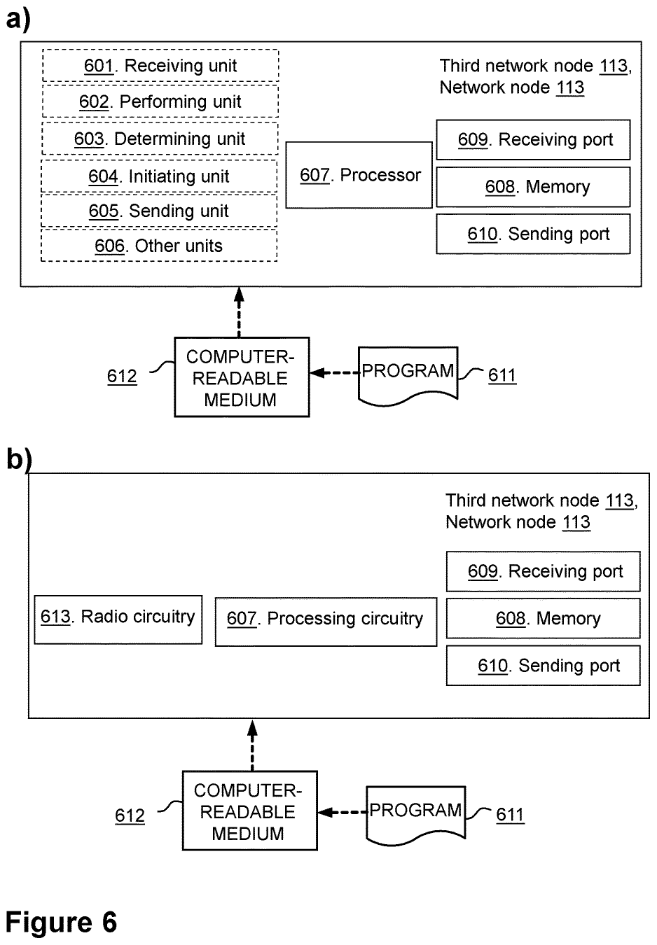

FIG. 6 depicts two different examples in panels a) and b), respectively, of the arrangement that the third network node 113, which may be also referred to herein as a network node 113, may comprise to perform the method actions described above in relation to FIG. 4. In some embodiments, the third network node 113 may comprise the following arrangement depicted in FIG. 6a. The network node 113 may be understood to be for handling the re-establishment information after the failure by the wireless device 130. The network node 113 may be configured to operate in the wireless communications network 100.

In some embodiments, the wireless communications network 100 may support New Radio (NR).

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the one or more indications may be configured to be received in a report, which may be, e.g., an RLF report.

In FIG. 6, optional units are indicated with dashed boxes.

The network node 113, e.g., the third network node 113, is configured to perform the receiving in Action 402, e.g., by means of a receiving unit 601 within the (third) network node 113, configured to receive, from the wireless device 130, the one or more indications configured to indicate the failure. The one or more indications are configured to comprise at least the first indication. The first indication is configured to indicate whether the first cell 123 configured to be selected by the wireless device 130 for the reestablishment procedure configured to be triggered by the failure, was a candidate cell in the inter-cell mobility configuration. The inter-cell mobility configuration is configured to be received by the wireless device 130 in the previous indication to perform the L1/L2 mobility procedure.

In some embodiments, at least one of the following may apply: a) the failure may be configured to be the mobility procedure, b) the failure may be configured to be one of: the radio link failure and the handover failure, c) the mobility procedure may be configured to be the L1/L2 inter-cell mobility, d) the one or more indications may be configured to be received in the report, e) the one or more indications may be configured to be received in the UEInformationResponse message, and g) the inter-cell mobility configuration may be configured to be the L1/L2 inter-cell mobility configuration.

In some embodiments, the one or more indications may be configured to further comprise at least one of: a) the second indication configured to indicate the one or more candidate cells 125 as configured in the inter-cell mobility configuration, b) the third indication configured to indicate the time elapsed between the first time of reception of the inter-cell mobility configuration, and the second time when the failure was declared, c) the third indication, further configured to indicate the third time elapsed between the fourth time of reception of the last inter-cell mobility configuration configured to have included, as candidate cell, the first cell 123 configured to be selected for the reestablishment procedure, and the second time when the failure was declared, and d) the fourth indication configured to indicate at least one of: a) the first location information at the fourth time, and b) the second location information at the second time.

In some embodiments, at least one of the following may apply: a) the first indication may be configured to be indicated by the one-bit flag, b) the first indication may be configured to be indicated by the reest-L1L2Candidate IE, c) the first indication may be configured to further indicate the additional L1/L2 mobility related measurements, d) the first indication with the additional L1/L2 mobility related measurements may be configured to be indicated by the reest-L1L2meas IE, e) the first indication with the additional L1/L2 mobility related measurements may be configured to be indicated by the reConnect-L1L2meas, f) the second indication may be configured to be indicated by the candidates-L1L2Mobility IE, g) the second indication may be configured to be indicated by the candidate-L1L2flag flag, h) the second indication may be further configured to indicate the additional L1/L2 mobility related measurements, i) the second indication with the additional L1/L2 mobility related measurements may be configured to be indicated by the candidate-L1L2meas IE, j) the third indication may be configured to be indicated by the another IE, and k) the fourth indication may be configured to be indicated by the yet another IE.

The network node 113, e.g., the third network node 113 may be configured to perform the performing of Action 401, e.g., by means of a performing unit 602 within the (third) network node 113, configured to, perform the reestablishment procedure or reconnection procedure with the wireless device 130, and the one or more indications may be configured to be received after having performed the reestablishment procedure.

In some embodiments, one of the following may apply: a) the reestablishment procedure may be configured to be performed after the wireless device 130 may be configured to have gone to idle mode after the failed mobility procedure, and b) the wireless device 130 may be configured to reconnect to the network node 113 after the reestablishment procedure may have failed.

In some embodiments, the wireless device 130 may be configured to reconnect to the network node 113 after the reestablishment procedure fails, and the network node 113, e.g., the third network node 113, may be further configured to perform the receiving of Action 406, e.g., by means of the receiving unit 601 within the (third) network node 113, configured to, receive, from the wireless device 130, after reconnection, at least one of: i) the fifth indication configured to indicate whether the second cell 124 configured to be selected by the wireless device 130 for the reconnection procedure configured to be triggered by the failed reestablishment procedure, was a candidate cell in the inter-cell mobility configuration configured to be received in the previous indication, and ii) the sixth indication configured to indicate the time elapsed between the first time of reception of the inter-cell mobility configuration, and the fifth time of the reconnection upon selection of the second cell 124.

In some embodiments, the fifth indication may be configured to be indicated by the reConnect-L1L2Candidate IE.

In some embodiments, the network node 113 may be further configured to at least one of the following three configurations.

In some embodiments, the network node 113, e.g., the third network node 113 may be configured to perform the determining of Action 403, e.g., by means of a determining unit 603 within the (third) network node 113, configured to determine, based on the one or more indications configured to be received, the one or more characteristics of the inter-cell mobility configuration configured to be selected from: i) whether the first cell 123 configured to be selected by the wireless device 130 for the reestablishment procedure was a candidate cell in the inter-cell mobility configuration, ii) the measurement results of the one or more candidate cells 125 as configured in the inter-cell mobility configuration, and c) how long the wireless device 130 has been configured with the inter-cell mobility configuration before the failure occurred.

In some embodiments, the network node 113, e.g., the third network node 113 may be configured to perform the initiating of Action 404, e.g., by means of an initiating unit 604 within the (third) network node 113, configured to, initiate, based on the result of the determination, adapting the one or more procedures of the inter-cell mobility configuration.

In some embodiments, the network node 113, e.g., the third network node 113 may be configured to perform the determining in Action 403, e.g., by means of a sending unit 605 within the third network node 113, configured to send, based on the adaptation, the updated inter-cell mobility configuration configured to comprise the one or more procedures configured to be adapted.

In some embodiments, at least one of the following may apply: a) with the proviso that the first cell 123 was not a candidate cell in the inter-cell mobility configuration, the adapting may be configured to comprise adding the first cell 123 to the list of candidate cells in the inter-cell mobility configuration, b) with the proviso that the measurement results indicate that the first candidate cell 126 has better measurement results, the adapting may be configured to comprise triggering the mobility procedure towards the first candidate cell 126, c) with the proviso that the measurement results indicate that the first candidate cell 126 has poor measurement results, the adapting may be configured to comprise removing the first candidate cell 126 from the one or more candidate cells 125, and d) with the proviso that the measurement results indicate that the first neighbor cell 127 has good measurement results, and the first neighbor cell 127 may be not configured as a candidate cell in the inter-cell mobility configuration, the adapting may be configured to comprise adding the first neighbor cell 127 to the list of candidate cells in the inter-cell mobility configuration.

Other units 606 may be comprised in the third network node 113.

The embodiments herein in the third network node 113 may be implemented through one or more processors, such as a processor 607 in the third network node 113 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third network node 113. One such carrier may be in the form of a CD ROM disc. It is however feasible with other data carriers such as a memory stick. The computer program code may furthermore be provided as pure program code on a server and downloaded to the third network node 113.

The third network node 113 may further comprise a memory 608 comprising one or more memory units. The memory 608 is arranged to be used to store obtained information, store data, configurations, schedulings, and applications etc. to perform the methods herein when being executed in the third network node 113.

In some embodiments, the third network node 113 may receive information from, e.g., the wireless device 130, the first network node 111, the second network node 112, the source cell 121, the target cell 122, the first cell 123, the second cell 124, the one or more candidate cells 125, the first candidate cell 126, the first neighbor cell 127 and/or another cell, network node or node, through a receiving port 609. In some embodiments, the receiving port 609 may be, for example, connected to one or more antennas in third network node 113. In other embodiments, the third network node 113 may receive information from another structure in the wireless communications network 100 through the receiving port 609. Since the receiving port 609 may be in communication with the processor 607, the receiving port 609 may then send the received information to the processor 607. The receiving port 609 may also be configured to receive other information.

The processor 607 in the third network node 113 may be further configured to transmit or send information to e.g., the wireless device 130, the wireless device 130, the first network node 111, the second network node 112, the source cell 121, the target cell 122, the first cell 123, the second cell 124, the one or more candidate cells 125, the first candidate cell 126, the first neighbor cell 127, another cell, network node or node, and/or another structure in the wireless communications network 100, through a sending port 610, which may be in communication with the processor 607, and the memory 608.

Those skilled in the art will also appreciate that the different units 601-606 described above may refer to a combination of analog and digital modules, and/or one or more processors configured with software and/or firmware, e.g., stored in memory, that, when executed by the one or more processors such as the processor 607, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 601-606 described above may be implemented as one or more applications running on one or more processors such as the processor 607.

Thus, the methods according to the embodiments described herein for the third network node 113 may be respectively implemented by means of a computer program 611 product, comprising instructions, i.e., software code portions, which, when executed on at least one processor 607, cause the at least one processor 607 to carry out the actions described herein, as performed by the third network node 113. The computer program 611 product may be stored on a computer-readable storage medium 612. The computer-readable storage medium 612, having stored thereon the computer program 611, may comprise instructions which, when executed on at least one processor 607, cause the at least one processor 607 to carry out the actions described herein, as performed by the third network node 113. In some embodiments, the computer-readable storage medium 612 may be a non-transitory computer-readable storage medium, such as a CD ROM disc, or a memory stick. In other embodiments, the computer program 611 product may be stored on a carrier containing the computer program 611 just described, wherein the carrier is one of an electronic signal, optical signal, radio signal, or the computer-readable storage medium 612, as described above.

The third network node 113 may comprise a communication interface configured to facilitate communications between the third network node 113 and other nodes or devices, e.g., the wireless device 130, the wireless device 130, the first network node 111, the second network node 112, the source cell 121, the target cell 122, the first cell 123, the second cell 124, the one or more candidate cells 125, the first candidate cell 126, the first neighbor cell 127, another cell, network node or node, and/or another structure in the wireless communications network 100. The interface may, for example, include a transceiver configured to transmit and receive radio signals over an air interface in accordance with a suitable standard.

In other embodiments, the third network node 113 may comprise the following arrangement depicted in FIG. 6b. The third network node 113 may comprise a processing circuitry 607, e.g., one or more processors such as the processor 607, in the third network node 113 and the memory 608. The third network node 113 may also comprise a radio circuitry 613, which may comprise e.g., the receiving port 609 and the sending port 610. The processing circuitry 607 may be configured to, or operable to, perform the method actions according to FIG. 4, in a similar manner as that described in relation to FIG. 6a. The radio circuitry 613 may be configured to set up and maintain at least a wireless connection with the wireless device 130, the wireless device 130, the first network node 111, the second network node 112, the source cell 121, the target cell 122, the first cell 123, the second cell 124, the one or more candidate cells 125, the first candidate cell 126, the first neighbor cell 127, another cell, network node or node, and/or another structure in the wireless communications network 100. Circuitry may be understood herein as a hardware component.

Hence, embodiments herein also relate to the third network node 113 comprising the processing circuitry 607 and the memory 608, said memory 608 containing instructions executable by said processing circuitry 607, whereby the third network node 113 is operative to perform the actions described herein in relation to the third network node 113, e.g., FIG. 4.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

In a non-limiting example, L1 signalling may be understood as any operation with interaction/signalling between the Physical (PHY) layer of a radio network node, e.g., a gNB, and the PHY layer of a device, e.g., UE. In a non-limiting example, L2 signalling may be understood as any operation with interaction/signalling between at the Layer 2, e.g., MAC layer or RLC layer, between a RAN node, e.g., a gNB-DU, and a device, e.g., a UE.

In a non-limiting example, a mobility procedure may be understood as a procedure involving a change of a serving cell such as a PCell, PSCell, or secondary cell SCell.

In a non-limiting example, a mobility procedure may be understood as a procedure involving a change of a serving cell such as a PCell, PSCell, or secondary cell SCell.

### Examples Related to Embodiments Herein

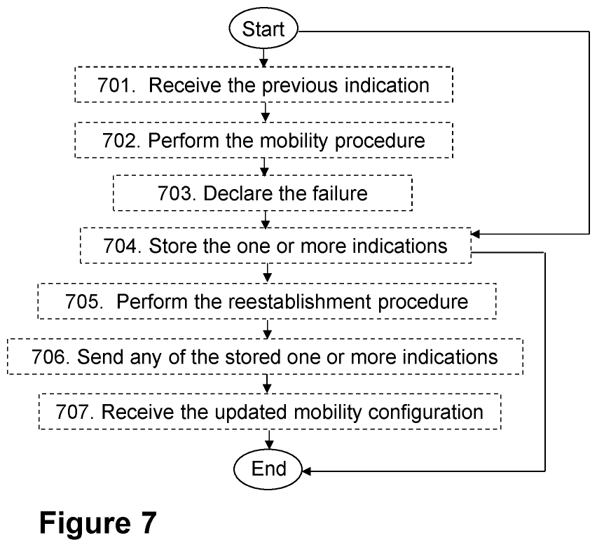

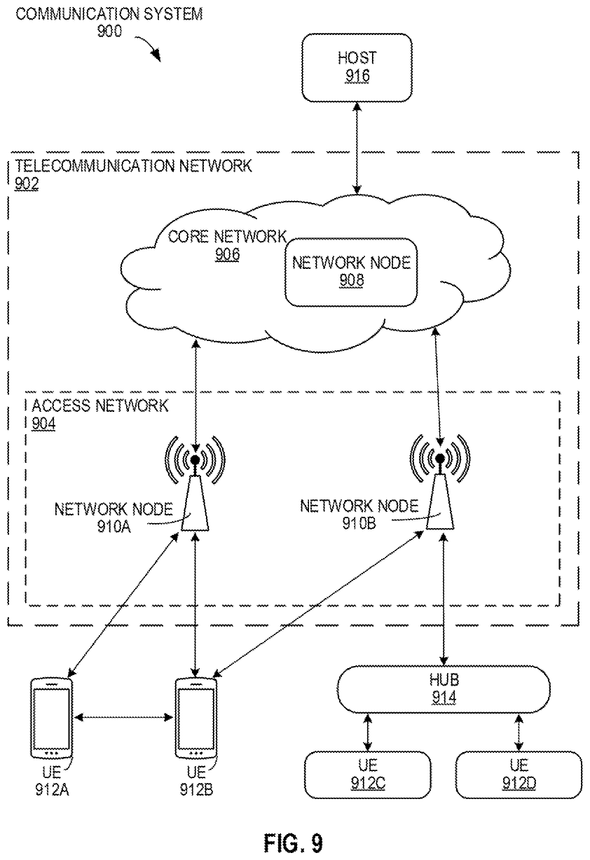

The wireless device 130 embodiments relate to FIG. 7, FIG. 5, FIG. 7 and FIG. 9.

A method, performed by a wireless device, such as the wireless device 130 is described herein. The method may be understood to be for handling re-establishment information after a failure in a mobility procedure by the wireless device 130, e.g., from the first network node 111 to the second network node 112. The wireless device 130 may be operating in a wireless communications network, such as the wireless communications network 100.

The failure may be, e.g., a radio link failure.

A mobility procedure may also be referred to herein simply as mobility.

In some particular embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 7. In FIG. 7, optional actions in some embodiments may be represented with dashed lines. In some embodiments, the actions may be performed in a different order than that depicted FIG. 7.
Storing/Logging/Recording 704 one or more indications. The wireless device 130 may be configured to perform the storing/logging/recording in this Action 704, e.g. by means of a storing unit 501 within the wireless device 130, configured to perform this action.

The storing/logging/recording in this Action 704 may be responsive to the declared failure.

The one or more indications may indicate the failed mobility procedure.

The one or more indications may comprise at least a first indication.

The first indication may indicate whether a cell, e.g., a first cell 123, selected by the wireless device 130 for a reestablishment procedure triggered by the failed mobility procedure, was a candidate cell in an inter-cell mobility configuration received in a previous indication to perform the mobility procedure that failed.

The previous indication may have been received, e.g., from the first network node 111, from the second network node 112, or from another network node operating in the wireless communications network 100.

In some embodiments, the method may comprise, additionally, or alternatively, the following action:
Sending 706 any of the stored one or more indications. The wireless device 130 may be configured to perform the sending of this Action 706, e.g. by means of a sending unit 502 within the wireless device, configured to perform this action.

The sending in this Action 705 may be, e.g., to the third network node 113, which may also be referred to simply as the network node 113. The third network node 113 may be serving the wireless device 130 in the wireless communications network 100.

The sending in this Action 706 may be performed, e.g., via the first link 141.

The sent one or more indications may be, e.g., a subset selected from the stored one or more indications.

In some examples, at least one of the following may apply:
the one or more indications may be sent in a report,
the one or more indications may be sent in a UEInformationResponse message,
the failure may be a radio link failure,
the mobility, e.g., the mobility procedure, may be an L1/L2 inter-cell mobility, and
the inter-cell mobility configuration may be an L1/L2 inter-cell mobility configuration.

In some examples, the one or more indications may further comprise at least one of:
a second indication; the second indication may indicate one or more candidate cells 125 as configured in the inter-cell mobility, e.g., L1/L2 inter-cell mobility, configuration,
a third indication; the third indication may indicate a time elapsed between a first time of reception of the inter-cell mobility, e.g., L1/L2 inter-cell mobility, configuration, and a second time when the failure, e.g., radio link failure, was declared,
the third indication, further indicating a third time elapsed between a fourth time of reception of a last inter-cell mobility, e.g., L1/L2 inter-cell mobility, configuration, and a second time when the failure, e.g., radio link failure, was declared, and
a fourth indication; the fourth indication may indicate at least one of: a) first location information at the fourth time, and b) second location information at the second time.

In some examples, at least one of the following may apply:
the first indication may be indicated by a reest-L1L2Candidate information element (IE),
the first indication may further indicate additional L1/L2 mobility related measurements,
the first indication with the additional L1/L2 mobility related measurements may be indicated by a reest-L1L2meas IE,
the first indication with the additional L1/L2 mobility related measurements may be indicated by a reConnect-L1L2meas,
the second indication may be indicated by a candidates-L1L2Mobility IE,
the second indication may be indicated by a candidate-L1L2flag flag,
the second indication may further indicate additional L1/L2 mobility related measurements, and
the second indication with the additional L1/L2 mobility related measurements may be indicated by a candidate-L1L2meas IE,
the third indication may be indicated by another IE, and
the fourth indication may be indicated by yet another IE.

In some embodiments, the method may comprise one or more of the following actions:
Receiving 701 the previous indication. The wireless device 130 may be configured to perform the receiving in this Action 701, e.g. by means of a receiving unit 503 within the wireless device 130, configured to perform this action.

The receiving in this Action 701 may be, e.g., from the first network node 111, from the second network node 112, or from another network node operating in the wireless communications network 100.
Performing 702 the mobility procedure. The wireless device 130 may be configured to perform the performing in this Action 702, e.g. by means of a performing unit 504, within the wireless device 130, configured to perform this action.

The mobility procedure may be, e.g., L1/L2 inter-cell mobility procedure.

The mobility procedure may be from the first network node 111 to the second network node 112, e.g., from the source cell 121 to the target cell 122.

The performing in this Action 702 may be, e.g., responsive to the received previous indication.
Declaring 703 the failure in the mobility procedure. The wireless device 130 may be configured to perform the declaring of this Action 703, e.g. by means of a declaring unit 505 within the wireless device 130, configured to perform this action.

The failure may be, e.g., radio link failure.
Performing 705 the reestablishment procedure or reconnection procedure. The wireless device 130 may be configured to perform the performing in this Action 702, e.g. by means of the performing unit 504, within the wireless device 130, configured to perform this action.

The reestablishment procedure or reconnection procedure may be, e.g., to the third network node 113 operating in the wireless communications network 100.

The performing in this Action 705 may be, e.g., responsive to the declared failure.
Receiving 707 an updated inter-cell mobility procedure configuration. The wireless device 130 may be configured to perform the receiving in this Action 707, e.g. by means of the receiving unit 503, within the wireless device 130, configured to perform this action.

The mobility procedure may be, e.g., L1/L2 inter-cell mobility procedure.

The receiving in this Action 707 may be from the third network node 113.

The receiving in this Action 707 may be, e.g., based on the sent one or more indications.

The updated configuration may comprise adapted one or more procedures e.g., at least one from: selection of candidate cells, triggering thresholds for the mobility procedure, and L3 mobility parameters.

In some examples, one of the following may apply:
a) the wireless device 130 may perform the reestablishment procedure after going to idle mode after the failed mobility procedure, and
b) the reestablishment procedure may fail and the wireless device 130 may reconnect to the third network node 113.

In some examples, the reestablishment procedure may fail and the wireless device 130 may reconnect to the third network node 113. In some of these examples, the storing in Action 704 may further comprise storing at least one of:
a fifth indication; the fifth indication may indicate whether a second cell 124 selected by the wireless device 130 for a reconnection procedure triggered by the failed reestablishment procedure, was a candidate cell in the inter-cell mobility configuration received in the previous indication, and
a sixth indication; the sixth indication may indicate a time elapsed between the first time of reception of the inter-cell mobility, e.g., L1/L2 inter-cell mobility, configuration, and a fifth time of the reconnection upon selection of the second cell 124,

Any of the fifth indication and the sixth indication may be optionally sent, e.g., to the third network node 113.

In some examples, the fifth indication may be indicated by a reConnect-L1L2Candidate IE.

Other units 506 may be comprised in the wireless device 130.

The wireless device 130 may also be configured to communicate user data with a host application unit in a host 716, 800, 902, e.g., via an OTT connection such as OTT connection 950.

In FIG. 5, optional units are indicated with dashed boxes.

The wireless device 130 may comprise an interface unit to facilitate communications between the wireless device 130 and other nodes or devices, e.g., the third network node 113, the host 716, 800, 902, or any of the other nodes. In some particular examples, the interface may, for example, include a transceiver configured to transmit and receive radio signals over an air interface in accordance with a suitable standard.

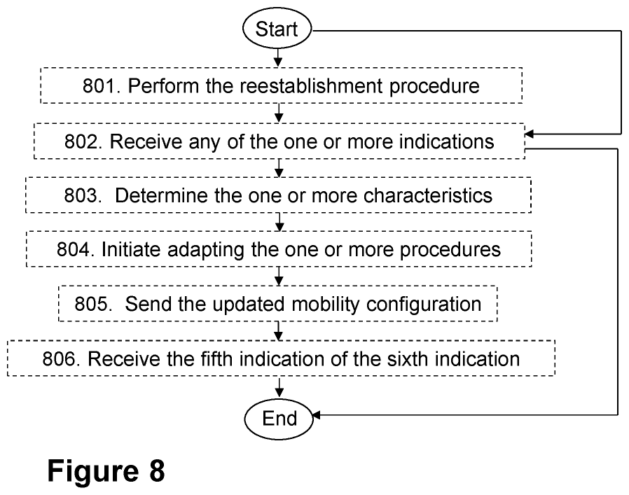

The third network node 113 embodiments relate to FIG. 8, FIG. 6, FIG. 7 and FIG. 9.

A method, performed by a network node, such as the third network node 113 is described herein. The method may be understood to be for handling re-establishment information after the failure in the mobility procedure by the wireless device 130, e.g., from the first network node 111 to the second network node 112. The third network node 113 may be operating in a wireless communications network, such as the wireless communications network 100.

A mobility procedure may also be referred to herein simply as mobility.

In some embodiments, the wireless communications network 100 may support New Radio (NR).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the third network node 113 is depicted in FIG. 8. In FIG. 8, optional actions in some embodiments may be represented with dashed lines. In some embodiments, the actions may be performed in a different order than that depicted FIG. 8.

The detailed description of some of the following corresponds to the same references provided above, in relation to the actions described for the wireless device 130 and will thus not be repeated here to simplify the description. For example, the failure may be, e.g., a radio link failure.
Receiving 802 the one or more indications, e.g., the subset of the one or more indications. The third network node 113 may be configured to perform the receiving in this Action 802, e.g. by means of a receiving unit 601 within the third network node 113, configured to perform this action.

The receiving in this Action 801 may be from the wireless device 130.

The receiving in this Action 801 may be performed, e.g., via the first link 141.

The one or more indications may indicate the failed mobility procedure.

The one or more indications may comprise at least the first indication.

The first indication may indicate whether the first cell 123 selected by the wireless device 130 for the reestablishment procedure triggered by the failed mobility procedure, was a candidate cell in the inter-cell mobility configuration received by the wireless device 130 in the previous indication to perform the mobility procedure that failed.

The previous indication may have been received, e.g., from the first network node 111, from the second network node 112, or from another network node operating in the wireless communications network 100.

In some examples, at least one of the following may apply:
the one or more indications may be received in the report,
the one or more indications may be received in the UEInformationResponse message,
the failure may be the radio link failure,
the mobility, e.g., the mobility procedure, may be the L1/L2 inter-cell mobility, and
the inter-cell mobility configuration may be the L1/L2 inter-cell mobility configuration.

In some examples, the one or more indications may further comprise at least one of:
the second indication; the second indication may indicate the one or more candidate cells 125 as configured in the inter-cell mobility, e.g., L1/L2 inter-cell mobility, configuration,
the third indication; the third indication may indicate the time elapsed between the first time of reception of the inter-cell mobility, e.g., L1/L2 inter-cell mobility, configuration, and the second time when the failure, e.g., radio link failure, was declared,
the third indication, further indicating the third time elapsed between the fourth time of reception of the last inter-cell mobility, e.g., L1/L2 inter-cell mobility, configuration, and the second time when the failure, e.g., radio link failure, was declared, and
the fourth indication; the fourth indication may indicate at least one of: a) the first location information at the fourth time, and b) the second location information at the second time.

In some examples, at least one of the following may apply:
the first indication may be indicated by the reest-L1L2Candidate information element (IE),
the first indication may further indicate the additional L1/L2 mobility related measurements,
the first indication with the additional L1/L2 mobility related measurements may be indicated by the reest-L1L2meas IE,
the first indication with the additional L1/L2 mobility related measurements may be indicated by the reConnect-L1L2meas,
the second indication may be indicated by the a candidates-L1L2Mobility IE,
the second indication may be indicated by the candidate-L1L2flag flag,
the second indication may further indicate additional L1/L2 mobility related measurements, and
the second indication with the additional L1/L2 mobility related measurements may be indicated by the candidate-L1L2meas IE,
the third indication may be indicated by the another IE, and
the fourth indication may be indicated by the yet another IE.

In some embodiments, the method may further comprise one or more of the following actions:
Performing 801 the reestablishment procedure or reconnection procedure. The third network node 113 may be configured to perform the performing in this Action 801, e.g. by means of a performing unit 602 within the third network node 113, configured to perform this action.

The performing of the reestablishment procedure or reconnection procedure in this Action 801 may be with the wireless device 130.

The one or more indications may be received after having performed the reestablishment procedure.

In some examples, one of the following may apply:
a) the reestablishment procedure may be performed after the wireless device 130 may have gone to idle mode after the failed mobility procedure, and
b) the reestablishment procedure may have failed and the wireless device 130 may reconnect to the third network node 113.

In some embodiments, e.g., wherein the reestablishment procedure may have failed and the wireless device 130 may reconnect to the third network node 113, the method may further comprise one or more of the following actions:
Receiving 806 at least one of the fifth indication and the sixth indication. The third network node 113 may be configured to perform the receiving in this Action 806, e.g. by means of the receiving unit 601 within the third network node 113, configured to perform this action.

The receiving in this Action 806 may be, from the wireless device 130, e.g., after reconnection.
the fifth indication may indicate whether the second cell 124 selected by the wireless device 130 for the reconnection procedure triggered by the failed reestablishment procedure, was a candidate cell in the inter-cell mobility configuration received in the previous indication, and
the sixth indication may indicate the time elapsed between the first time of reception of the inter-cell mobility, e.g., L1/L2 inter-cell mobility, configuration, and the fifth time of the reconnection upon selection of the second cell 124,

In some examples, the fifth indication may be indicated by the reConnect-L1L2Candidate IE.

In some embodiments, the method may further comprise one or more of the following actions:
Determining 803 one or more characteristics of the inter-cell mobility configuration. The third network node 113 may be configured to perform the determining in this Action 803, e.g. by means of a determining unit 603 within the third network node 113, configured to perform this action.

The determining in this Action 803 may be, based on the received one or more indications, e.g., the subset.

The determined one or more characteristics of the inter-cell mobility configuration may be e.g., selected from:
i. whether the first cell 123 selected by the wireless device 130 for the reestablishment procedure was a candidate cell in the inter-cell mobility configuration,
ii. measurement results of one or more candidate cells 125 as configured in the inter-cell mobility, e.g., L1/L2 inter-cell mobility, configuration, and
iii. how long the wireless device 130 has been configured with the in the inter-cell mobility, e.g., L1/L2 inter-cell mobility, configuration before the failure occurred,
Initiating 804 adapting one or more procedures of the inter-cell mobility, e.g., L1/L2 inter-cell mobility, configuration. The third network node 113 may be configured to perform the initiating in this Action 804, e.g. by means of an initiating unit 604 within the third network node 113, configured to perform this action.

Initiating may be understood as starting, facilitating, enabling, triggering or similar.

In some examples, adapting of the one or more procedures of the inter-cell mobility, e.g., L1/L2 inter-cell mobility, configuration, may be e.g., at least one from: selection of candidate cells, triggering thresholds for the mobility procedure, and L3 mobility parameters.

The initiating in this Action 804 may be e.g., based on a result of the determination.
Sending 805 an updated inter-cell mobility, e.g., L1/L2 inter-cell mobility, configuration. The third network node 113 may be configured to perform the determining in this Action 803, e.g. by means of a sending unit 605 within the third network node 113, configured to perform this action.

The updated inter-cell mobility, e.g., L1/L2 inter-cell mobility, configuration may comprise the adapted one or more procedures.

The sending of the updated inter-cell mobility, e.g., L1/L2 inter-cell mobility, configuration in this Action 805 may be based on the adaptation initiated in Action 804.

In some examples, at least one of the following may apply:
with the proviso that the first cell 123 was not a candidate cell in the inter-cell mobility configuration, the adapting may comprise adding the first cell 123 to a list of candidate cells in the inter-cell mobility configuration, e.g., for devices connected to a cell, e.g., a PCell, in which the failed mobility procedure was detected, and
with the proviso that the measurement results indicate that a first candidate cell 126 has better measurement results, the adapting may comprise triggering a mobility procedure towards the first candidate cell 126,
with the proviso that the measurement results indicate that the first candidate cell 126 has poor measurement results, the adapting may comprise removing the first candidate cell 126 from the one or more candidate cells 125,
with the proviso that the measurement results indicate that a first neighbor cell 127 has good measurement results, and the first neighbor cell 127 not a candidate cell in the inter-cell mobility configuration, the adapting may comprise adding the first neighbor cell 127 to the list of candidate cells in the inter-cell mobility configuration.

Other units 606 may be comprised in the third network node 113.

The third network node 113 may also be configured to communicate user data with a host application unit in a host 716, 800, 902, e.g., via a connection 960.

In FIG. 6, optional units are indicated with dashed boxes.

The third network node 113 may comprise an interface unit to facilitate communications between the third network node 113 and other nodes or devices, e.g., the wireless device 130, the first network node 111, the second network node 112, the another node, the host 716, 800, 902, or any of the other nodes. In some particular examples, the interface may, for example, include a transceiver configured to transmit and receive radio signals over an air interface in accordance with a suitable standard.

The third network node 113 may comprise an arrangement as shown in FIG. 6.

### EXAMPLES

EXAMPLE 1. A method performed by a wireless device (130), the method being for handling re-establishment information after a failure in a mobility procedure by the wireless device (130) from a first network node (111) to a second network node (112), the wireless device (130) operating in a wireless communications network (100), and the method comprising:
storing (704), responsive to the declared failure, one or more indications indicating the failed mobility procedure, the one or more indications comprising at least a first indication indicating whether a first cell (123) selected by the wireless device (130) for a reestablishment procedure triggered by the failed mobility procedure, was a candidate cell in an inter-cell mobility configuration received in a previous indication, from the first network node (111), to perform the mobility procedure that failed.

EXAMPLE 2. The method according to example 1, wherein at least one of:
the one or more indications are sent in a report,
the one or more indications are sent in a UEInformationResponse message,
the failure is a radio link failure,
the mobility, e.g., the mobility procedure, is an L1/L2 inter-cell mobility, and
the inter-cell mobility configuration is an L1/L2 inter-cell mobility configuration.

EXAMPLE 7. The method according to any of examples 1-2, wherein the one or more indications further comprise at least one of:
a second indication indicating one or more candidate cells (125) as configured in the inter-cell mobility, e.g., L1/L2 inter-cell mobility, configuration,
a third indication indicating a time elapsed between a first time of reception of the inter-cell mobility, e.g., L1/L2 inter-cell mobility, configuration, and a second time when the failure, e.g., radio link failure, was declared,
the third indication, further indicating a third time elapsed between a fourth time of reception of a last inter-cell mobility, e.g., L1/L2 inter-cell mobility, configuration, and a second time when the failure, e.g., radio link failure, was declared, and
a fourth indication indicating at least one of: a) first location information at the fourth time, and b) second location information at the second time.

EXAMPLE 8. The method according to example 7, wherein at least one of:
the first indication is indicated by a reest-L1L2Candidate information element, IE,
the first indication further indicates additional L1/L2 mobility related measurements,
the first indication with the additional L1/L2 mobility related measurements are indicated by a reest-L1L2meas IE,
the first indication with the additional L1/L2 mobility related measurements are indicated by a reConnect-L1L2meas,
the second indication is indicated by a candidates-L1L2Mobility IE,
the second indication is indicated by a candidate-L1L2flag flag,
the second indication further indicates additional L1/L2 mobility related measurements, and
the second indication with the additional L1/L2 mobility related measurements are indicated by a candidate-L1L2meas IE,
the third indication is indicated by another IE, and
the fourth indication is indicated by yet another IE.

EXAMPLE 5. The method according to any of examples 1-4, further comprising one or more of:
receiving (701) the previous indication from the first network node (111),
performing (702), responsive to the received previous indication, the mobility, e.g., L1/L2 inter-cell mobility, procedure, from the first network node (111) to the second network node (112),
declaring (703) the failure, e.g., radio link failure, in the mobility procedure,
performing (705) the reestablishment procedure or reconnection procedure to a third network node (113) operating in the wireless communications network (100),
sending (706) any of the stored one or more indications to the (third) network node (113), and
receiving (707), based on the sent one or more indications, an updated inter-cell mobility procedure, e.g., L1/L2 inter-cell mobility, procedure, configuration from the (third) network node (113), the updated configuration comprising adapted one or more procedures e.g., at least one from: selection of candidate cells, triggering thresholds for the mobility procedure, and L3 mobility parameters.

EXAMPLE 6. The method according to example 5, wherein one of:
a) the wireless device (130) performs the reestablishment procedure after going to idle mode after the failed mobility procedure, and
b) the reestablishment procedure fails and the wireless device (130) reconnects to the (third) network node (113).

EXAMPLE 7. The method according to example 6, wherein the reestablishment procedure fails and the wireless device (130) reconnects to the (third) network node (113), and wherein the storing (704) further comprises storing at least one of:
a fifth indication indicating whether a second cell (124) selected by the wireless device (130) for a reconnection procedure triggered by the failed reestablishment procedure, was a candidate cell in the inter-cell mobility configuration received in the previous indication, and
a sixth indication indicating a time elapsed between a first time of reception of the inter-cell mobility, e.g., L1/L2 inter-cell mobility, configuration, and a fifth time of the reconnection upon selection of the second cell (124).

EXAMPLE 8. The method according to example 7, wherein the fifth indication is indicated by a reConnect-L1L2Candidate IE.

EXAMPLE 9. A method performed by a (third) network node (113), the method being for handling re-establishment information after a failure in a mobility procedure by the wireless device (130) from a first network node (111) to a second network node (112), the third network node (113) operating in a wireless communications network (100), and the method comprising:
receiving (802), from the wireless device (130), one or more indications indicating the failed mobility procedure, the one or more indications comprising at least a first indication indicating whether a first cell (123) selected by the wireless device (130) for a reestablishment procedure triggered by the failed mobility procedure, was a candidate cell in an inter-cell mobility configuration received by the wireless device (130) in a previous indication, from the first network node (111), to perform the mobility procedure that failed.

EXAMPLE 10. The method according to example 9, wherein at least one of:
the one or more indications are received in a report,
the one or more indications are received in a UEInformationResponse message,
the failure is a radio link failure,
the mobility is an L1/L2 inter-cell mobility, and
the inter-cell mobility configuration is an L1/L2 inter-cell mobility configuration.

EXAMPLE 11. The method according to any of examples 9-10, wherein the one or more indications further comprise at least one of:
a second indication indicating one or more candidate cells (125) as configured in the inter-cell mobility, e.g., L1/L2 inter-cell mobility, configuration,
a third indication indicating a time elapsed between a first time of reception of the inter-cell mobility, e.g., L1/L2 inter-cell mobility, configuration, and a second time when the failure, e.g., radio link failure, was declared,
the third indication, further indicating a third time elapsed between a fourth time of reception of a last inter-cell mobility, e.g., L1/L2 inter-cell mobility, configuration, and a second time when the failure, e.g., radio link failure, was declared, and
a fourth indication indicating at least one of: a) first location information at the fourth time, and b) second location information at the second time.

EXAMPLE 12. The method according to example 11, wherein at least one of:
the first indication is indicated by a reest-L1L2Candidate information element, IE,
the first indication further indicates additional L1/L2 mobility related measurements,
the first indication with the additional L1/L2 mobility related measurements are indicated by a reest-L1L2meas IE,
the first indication with the additional L1/L2 mobility related measurements are indicated by a reConnect-L1L2meas,
the second indication is indicated by a candidates-L1L2Mobility IE,
the second indication is indicated by a candidate-L1L2flag flag,
the second indication further indicates additional L1/L2 mobility related measurements, and
the second indication with the additional L1/L2 mobility related measurements are indicated by a candidate-L1L2meas IE,
the third indication is indicated by another IE, and
the fourth indication is indicated by yet another IE.

EXAMPLE 13. The method according to any of examples 9-12, further comprising one or more of:
performing (801) the reestablishment procedure or reconnection procedure with the wireless device (130), and wherein the one or more indications are received after having performed the reestablishment procedure.

EXAMPLE 14. The method according to example 13, wherein one of:
a) the reestablishment procedure is performed after the wireless device (130) has gone to idle mode after the failed mobility procedure, and
b) the reestablishment procedure has failed and the wireless device (130) reconnects, e.g., to the (third) network node (113).

EXAMPLE 15. The method according to example 15, wherein the reestablishment procedure fails and the wireless device (130) reconnects to the (third) network node (113), and wherein the method further comprises:
receiving (806), from the wireless device (130), after reconnection, at least one of:
   i. a fifth indication indicating whether a second cell (124) selected by the wireless device (130) for a reconnection procedure triggered by the failed reestablishment procedure, was a candidate cell in the inter-cell mobility configuration received in the previous indication, and
   ii. a sixth indication indicating a time elapsed between a first time of reception of the inter-cell mobility, e.g., L1/L2 inter-cell mobility, configuration, and a fifth time of the reconnection upon selection of the second cell (124).

EXAMPLE 16. The method according to example 15, wherein the fifth indication is indicated by a reConnect-L1L2Candidate IE.

EXAMPLE 17. The method according to any of examples 9-16, wherein the method further comprises at least one of:
determining (803), based on the received one or more indications, one or more characteristics of the inter-cell mobility configuration, e.g., selected from:
   i. whether the first cell (123) selected by the wireless device (130) for the reestablishment procedure was a candidate cell in the inter-cell mobility configuration,
   ii. measurement results of one or more candidate cells (125) as configured in the inter-cell mobility, e.g., L1/L2 inter-cell mobility, configuration,
   iii. how long the wireless device (130) has been configured with the in the inter-cell mobility, e.g., L1/L2 inter-cell mobility, configuration before the failure occurred,
initiating (804), based on a result of the determination, adapting one or more procedures of the inter-cell mobility, e.g., L1/L2 inter-cell mobility, configuration, e.g., at least one from: selection of candidate cells, triggering thresholds for the mobility procedure, and L3 mobility parameters, and.
sending (805), based on the adaptation, an updated inter-cell mobility, e.g., L1/L2 inter-cell mobility, configuration comprising the adapted one or more procedures.

EXAMPLE 18. The method according to example 17, wherein at least one of:
with the proviso that the first cell (123) was not a candidate cell in the inter-cell mobility configuration, the adapting comprises adding the first cell (123) to a list of candidate cells in the inter-cell mobility configuration, e.g., for devices connected to a cell, e.g., a PCell, in which the failed mobility procedure was detected, and
with the proviso that the measurement results indicate that a first candidate cell (126) has better measurement results, the adapting comprises triggering a mobility procedure towards the first candidate cell (126),
with the proviso that the measurement results indicate that the first candidate cell (126) has poor measurement results, the adapting comprises removing the first candidate cell (126) from the one or more candidate cells (125),
with the proviso that the measurement results indicate that a first neighbor cell (127) has good measurement results, and the first neighbor cell (127) not a candidate cell in the inter-cell mobility configuration, the adapting comprises adding the first neighbor cell (127) to the list of candidate cells in the inter-cell mobility configuration.

### Further Extensions And Variations

FIG. 9 shows an example of a communication system 900 in accordance with some embodiments.

In the example, the communication system 900, such as the wireless communications network 100, includes a telecommunication network 902 that includes an access network 904, such as a radio access network (RAN), and a core network 906, which includes one or more core network nodes 908. The access network 904 includes one or more access network nodes, such as the third network node 113 or the network node 113. For example, network nodes 910a and 910b, one or more of which may be generally referred to as network nodes 910, or any other similar 3rd Generation Partnership Project (3GPP) access node or non-3GPP access point. The communications system 900 comprises a plurality of wireless devices, such as the wireless device 130. In FIG. 9, the plurality of wireless devices comprises UEs 912a, 912b, 912c, and 912d, one or more of which may be generally referred to as UEs 912. The network nodes 910 facilitate direct or indirect connection of user equipment (UE), such as by connecting UEs 912a, 912b, 912c, and 912d to the core network 906 over one or more wireless connections. Any of the UEs 912a, 912b, 912c, and 912d are examples of the wireless device 130.

In relation to FIGS. 9, 10, and 11, which are described next, it may be understood that any UE is an example of the wireless device 130, and that any description provided for the UE 912 or for the UE 1106 equally applies to the wireless device 130. It may be also understood that any network node is an example of the third network node 113 or the network node 113, and that any description provided for any network node 910 or for the network node 1104 equally applies to the third network node 113 or the network node 113. It may further be understood that the communication system 900 is an example of the wireless communication network 100, and that any description provided for the communication system 900 equally applies to the wireless communication network 100.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless device 130, exemplified in FIG. 9 as the UEs 912, may be any of a wide variety of communication devices, including wireless devices arranged, configured, and/or operable to communicate wirelessly with the third network node 113 or the network node 113, exemplified in FIG. 9 as network nodes 910, and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes, e.g., core network node 908, that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, New Radio (NR) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs, e.g., UE 912c and/or 912d, and network nodes, e.g., network node 910b. In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

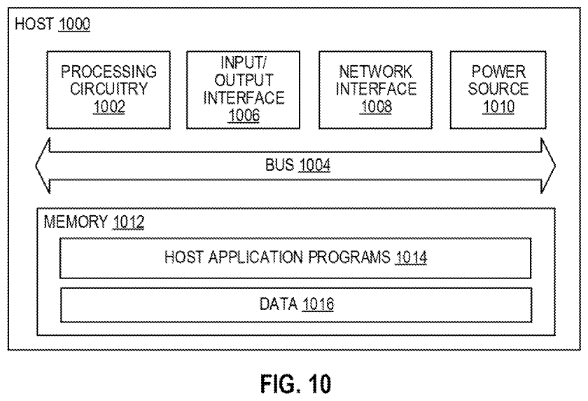

FIG. 10 is a block diagram of a host 1000, which may be an embodiment of the host 916 of FIG. 9, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs, (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

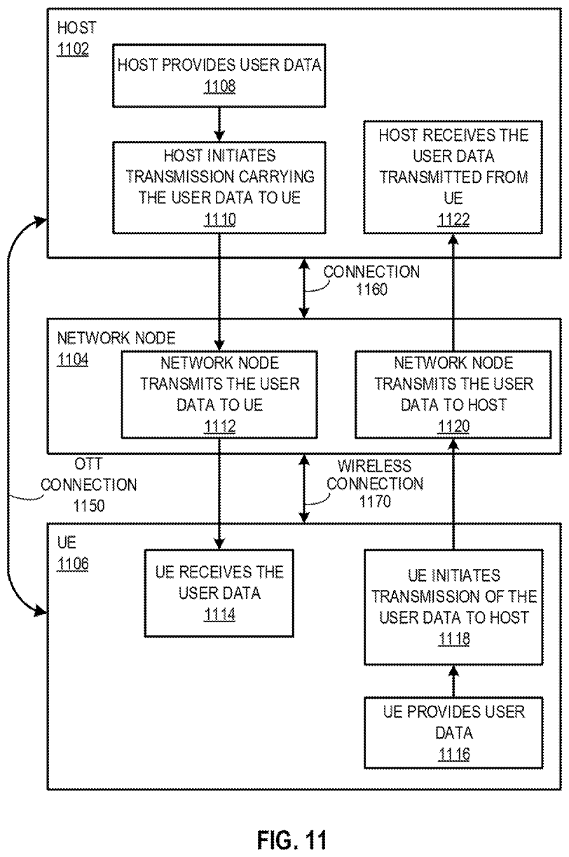

FIG. 11 shows a communication diagram of a host 1102 communicating via a network node 1104 with a UE 1106 over a partially wireless connection in accordance with some embodiments. Example implementations, in accordance with various embodiments, of the UE, such as a UE 912a of Figure QQ, network node, such as network node 910a of FIG. 9, and host, such as host 916 of FIG. 9 and/or host 1000 of FIG. 10, discussed in the preceding paragraphs will now be described with reference to FIG. 11.

Like host 1000, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 906 of FIG. 9) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the data rate, latency, power consumption and thereby provide benefits such as reduced user waiting time, reduced overhead, and extended battery lifetime.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion, e.g., controlling traffic lights. As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors, not shown, may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

The wireless device 130 embodiments relate to FIG. 3, FIG. 5, FIG. 7, FIG. 9 and FIG. 11.

The wireless device 130 may also be configured to communicate user data with a host application unit in a host 916, 1000, 1102, e.g., via an OTT connection such as OTT connection 1150.

The wireless device 130 may comprise an interface unit to facilitate communications between the wireless device 130 and other nodes or devices, e.g., the third network node 113 or the network node 113, the host 916, 1000, 1102, or any of the other nodes. In some particular examples, the interface may, for example, include a transceiver configured to transmit and receive radio signals over an air interface in accordance with a suitable standard.

The third network node 113 or the network node 113 embodiments relate to FIG. 4, FIG. 6, FIG. 8, FIG. 9 and FIG. 11.

The third network node 113 or the network node 113 may also be configured to communicate user data with a host application unit in a host 916, 1000, 1102, e.g., via a connection 1160.

The third network node 113 or the network node 113 may comprise an interface unit to facilitate communications between the third network node 113 or the network node 113 and other nodes or devices, e.g., the wireless device 130, the first network node 111, the second network node 112, the another node, the host 916, 1000, 1102, or any of the other nodes. In some particular examples, the interface may, for example, include a transceiver configured to transmit and receive radio signals over an air interface in accordance with a suitable standard.

### Further Numbered Embodiments

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the third network node 113 or the network node 113.
2. The host of the previous embodiment, wherein:
the processing circuitry of the host is configured to execute a host application that provides the user data; and
the UE comprises processing circuitry configured to execute a client application associated with the host application to receive the transmission of user data from the host.
3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the third network node 113 or the network node 113.
4. The method of the previous embodiment, further comprising, at the network node, transmitting the user data provided by the host for the UE.
5. The method of any of the previous 2 embodiments, wherein the user data is provided at the host by executing a host application that interacts with a client application executing on the UE, the client application being associated with the host application.
6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the third network node 113 or the network node 113.
7. The communication system of the previous embodiment, further comprising:
the network node; and/or
the user equipment.
8. The communication system of the previous 2 embodiments, wherein:
the processing circuitry of the host is configured to execute a host application, thereby providing the user data; and
the host application is configured to interact with a client application executing on the UE, the client application being associated with the host application.
9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the third network node 113 or the network node 113.
10. The host of the previous 2 embodiments, wherein:
the processing circuitry of the host is configured to execute a host application, thereby providing the user data; and
the host application is configured to interact with a client application executing on the UE, the client application being associated with the host application.
11. The host of the any of the previous 2 embodiments, wherein the initiating receipt of the user data comprises requesting the user data.
12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the third network node 113 or the network node 113.
13. The method of the previous embodiment, further comprising at the network node, transmitting the received user data to the host.
14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.
15. The host of the previous embodiment, wherein the cellular network further includes a network node configured to communicate with the UE to transmit the user data to the UE from the host.
16. The host of the previous 2 embodiments, wherein:
the processing circuitry of the host is configured to execute a host application, thereby providing the user data; and
the host application is configured to interact with a client application executing on the UE, the client application being associated with the host application.
17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.
18. The method of the previous embodiment, further comprising:
at the host, executing a host application associated with a client application executing on the UE to receive the user data from the UE.
19. The method of the previous embodiment, further comprising:
at the host, transmitting input data to the client application executing on the UE, the input data being provided by executing the host application, wherein the user data is provided by the client application in response to the input data from the host application.
20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.
21. The host of the previous embodiment, wherein the cellular network further includes a network node configured to communicate with the UE to transmit the user data from the UE to the host.
22. The host of the previous 2 embodiments, wherein:
the processing circuitry of the host is configured to execute a host application, thereby providing the user data; and
the host application is configured to interact with a client application executing on the UE, the client application being associated with the host application.
23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.
24. The method of the previous embodiment, further comprising:
at the host, executing a host application associated with a client application executing on the UE to receive the user data from the UE.
25. The method of the previous embodiments, further comprising:
at the host, transmitting input data to the client application executing on the UE, the input data being provided by executing the host application,
wherein the user data is provided by the client application in response to the input data from the host application.

### REFERENCES

1. RP-211586, 3GPP work item description: Further enhancements on MIMO for NR, Samsung, 3GPP TSG RAN Meeting #92e, Electronic Meeting, Jun. 14-18, 2021
2. RP-213565, 3GPP work item description: Further NR mobility enhancements, MediaTek, 3GPP TSG RAN Meeting #94e, Electronic Meeting, Dec. 6-17, 2021

| Abbreviation | Explanation |
|---|---|
| CE | Control Element |
| CHO | Conditional Handover |
| DCI | Downlink Control Information |
| HOF | Handover Failure |
| IE | Information Element |
| LTE | Long Term Evolution |
| MAC | Medium Access Control |
| MHI | Mobility History Report |
| MCG | Master Cell Group |
| MN | Master Node |
| NR | New Radio |
| PCI | Physical cell identifier |
| RAN | Radio Access Network |
| RRC | Radio Resource Control |
| RLF | Radio Link Failure |
| SCG | Secondary Cell Group |
| SN | Secondary Node |
| UE | User Equipment |
| gNB | Base station in NR |
| CU | Centralize unit |
| DU | Distributed unit |

1.-36. (canceled)

37. A method performed by a wireless device for handling re-establishment information after a failure in a wireless communications network, and the method comprising:
storing, responsive to declaration of the failure, one or more indications of the failure, wherein the one or more indications comprise a first indication of whether a first cell selected by the wireless device for a reestablishment procedure, triggered by the failure, was a candidate cell in an inter-cell mobility configuration indicated by a previous indication to perform a layer-1/layer-2 (L1/L2) mobility procedure.

38. The method according to claim 37, wherein the one or more indications also comprise at least one of the following:
a second indication of one or more candidate cells as configured in the inter-cell mobility configuration,
a third indication of one or more of the following times elapsed:
a time elapsed between the following: a first time of reception of the inter-cell mobility configuration, and a second time when the failure was declared,
a time elapsed between the following: a fourth time of reception of a last inter-cell mobility configuration that includes the first cell as candidate cell, and the second time when the failure was declared, and
a fourth indication of at least one of the following: a first location information at the fourth time, and a second location information at the second time.

39. The method according to claim 38, further comprising sending any of the stored one or more indications to a network node operating in the wireless communications network, wherein at least one of the following applies to the one or more indications sent to the network node:
the first indication is a one-bit flag,
the first indication is a reest-L1L2Candidate information element (IE),
the first indication further indicates additional L1/L2 mobility related measurements,
the first indication is a reest-L1L2meas IE or a reConnect-L1L2meas IE that includes the additional L1/L2 mobility related measurements
the second indication is a candidates-L1L2Mobility IE or a candidate-L1L2flag flag,
the second indication further indicates the additional L1/L2 mobility related measurements,
the second indication is a candidate-L1L2meas IE that includes the additional L1/L2 mobility related measurements,
the third indication is a timeSinceL1L1Config 1E, and
the fourth indication is a different IE than at least one of the first, second, and third indications.

40. The method according to claim 37, further comprising one or more of the following:
receiving the previous indication from a first network node;
performing, responsive to the previous indication, L1/L2 inter-cell mobility procedure, from the first network node to a second network node operating in the wireless communications network;
declaring the failure;
performing the reestablishment procedure or reconnection procedure to a third network node operating in the wireless communications network; and
sending any of the stored one or more indications to a network node operating in the wireless communications network and receiving, based on the one or more indications sent, an updated inter-cell mobility procedure configuration from the network node, the updated configuration comprising adapted one or more procedures.

41. The method according to claim 40, wherein the wireless device performs the reestablishment procedure after going to idle mode or after radio link failure.

42. The method according to claim 40, wherein the reestablishment procedure fails and the wireless device reconnects to the network node, and the one or more indications further comprise at least one of the following:
a fifth indication of whether a second cell, selected by the wireless device for a reconnection procedure triggered by the failed reestablishment procedure, was a candidate cell in the inter-cell mobility configuration indicated by the previous indication, and
a sixth indication of a time elapsed between the following: a first time of reception of the inter-cell mobility configuration, and a fifth time of the reconnection upon selection of the second cell.

43. A method performed by a network node for handling re-establishment information after a failure by a wireless device in a wireless communications network, the method comprising:
receiving, from the wireless device, one or more indications indicating the failure, wherein the one or more indications comprise a first indication of whether a first cell selected by the wireless device for a reestablishment procedure, triggered by the failure, was a candidate cell in an inter-cell mobility configuration indicated by a previous indication to perform a layer-1/layer-2 (L1/L2) mobility procedure.

44. The method according to claim 43, wherein the one or more indications also comprise at least one of the following:
a second indication of one or more candidate cells as configured in the inter-cell mobility configuration,
a third indication of one or more of the following times elapsed:
a time elapsed between the following: a first time of reception of the inter-cell mobility configuration, and a second time when the failure was declared,
a time elapsed between the following: a fourth time of reception of a last inter-cell mobility configuration that includes the first cell as candidate cell, and the second time when the failure was declared, and
a fourth indication of at least one of the following: a first location information at the fourth time, and a second location information at the second time.

45. The method according to claim 44, wherein at least one of the following applies:
the first indication is a one-bit flag,
the first indication is a reest-L1L2Candidate information element (IE),
the first indication further indicates additional L1/L2 mobility related measurements,
the first indication is a reest-L1L2meas IE or a reConnect-L1L2meas IE that includes the additional L1/L2 mobility related measurements
the second indication is a candidates-L1L2Mobility IE or a candidate-L1L2flag flag,
the second indication further indicates the additional L1/L2 mobility related measurements,
the second indication is a candidate-L1L2meas IE that includes the additional L1/L2 mobility related measurements,
the third indication is a timeSinceL1L1Config 1E, and
the fourth indication is a different IE than at least one of the first, second, and third indications.

46. The method according to claim 43, further comprising performing the reestablishment procedure or reconnection procedure with the wireless device, and wherein the one or more indications are received after having performed the reestablishment procedure.

47. The method according to claim 46, wherein the reestablishment procedure is performed after the wireless device has gone to idle mode after the failed mobility procedure.

48. The method according to claim 46, wherein the reestablishment procedure fails and the wireless device reconnects to the network node, and the one or more indications further comprise at least one of the following received after the wireless device reconnects:
a fifth indication of whether a second cell, selected by the wireless device for a reconnection procedure triggered by the failed reestablishment procedure, was a candidate cell in the inter-cell mobility configuration indicated by the previous indication, and
a sixth indication of a time elapsed between the following: a first time of reception of the inter-cell mobility configuration, and a fifth time of the reconnection upon selection of the second cell.

49. The method according to claim 43, further comprising at least one of the following:
determining, based on the received one or more indications, one or more of the following characteristics of the inter-cell mobility configuration:
whether the first cell, selected by the wireless device for the reestablishment procedure, was a candidate cell in the inter-cell mobility configuration;
measurement results of one or more candidate cells as configured in the inter-cell mobility configuration; and
how long the wireless device has been configured with the inter-cell mobility configuration before the failure occurred;
based on a result of the determination, initiating an adaption of one or more procedures of the inter-cell mobility configuration, and
sending an updated inter-cell mobility configuration that comprises or indicates the adapted one or more procedures.

50. The method according to claim 49, wherein at least one of the following applies:
when the first cell was not a candidate cell in the inter-cell mobility configuration, the adaptation comprises adding the first cell to a list of candidate cells in the inter-cell mobility configuration,
when the measurement results indicate that a first candidate cell has better measurement results, the adaptation comprises triggering a mobility procedure towards the first candidate cell,
when the measurement results indicate that the first candidate cell has poor measurement results, the adaptation comprises removing the first candidate cell from the one or more candidate cells, and
when the measurement results indicate that a first neighbor cell has good measurement results and the first neighbor cell is not a candidate cell in the inter-cell mobility configuration, the adaptation comprises adding the first neighbor cell to the list of candidate cells in the inter-cell mobility configuration.

51. A wireless device configured to handle re-establishment information after a failure in a wireless communications network, the wireless device comprising:
radio circuitry configured to communicate with the wireless communication network; and
processing circuitry operably coupled to the radio circuitry, wherein the processing circuitry and the radio circuitry are configured to:
store, responsive to declaration of the failure, one or more indications of the failure, wherein the one or more indications comprise a first indication of whether a first cell selected by the wireless device for a reestablishment procedure, triggered by the failure, was a candidate cell in an inter-cell mobility configuration indicated by a previous indication to perform a layer-1/layer-2 (L1/L2) mobility procedure.

52. The wireless device according to claim 51, wherein the one or more indications further comprise at least one of the following:
a second indication of one or more candidate cells as configured in the inter-cell mobility configuration,
a third indication of one or more of the following times elapsed:
a time elapsed between the following: a first time of reception of the inter-cell mobility configuration, and a second time when the failure was declared,
a time elapsed between the following: a fourth time of reception of a last inter-cell mobility configuration that includes the first cell as candidate cell, and the second time when the failure was declared, and
a fourth indication of at least one of the following: a first location information at the fourth time, and a second location information at the second time.

53. The wireless device according to claim 52, wherein the processing circuitry and the radio circuitry are further configured to send any of the stored one or more indications to a network node operating in the wireless communications network, wherein at least one of the following applies to the one or more indications sent to the network node:
the first indication is a one-bit flag,
the first indication is a reest-L1L2Candidate information element (IE),
the first indication further indicates additional L1/L2 mobility related measurements,
the first indication is a reest-L1L2meas IE or a reConnect-L1L2meas IE that includes the additional L1/L2 mobility related measurements
the second indication is a candidates-L1L2Mobility IE or a candidate-L1L2flag flag,
the second indication further indicates the additional L1/L2 mobility related measurements,
the second indication is a candidate-L1L2meas IE that includes the additional L1/L2 mobility related measurements,
the third indication is a timeSinceL1L1Config 1E, and
the fourth indication is a different IE than at least one of the first, second, and third indications.

54. The wireless device according to claim 51, wherein the processing circuitry and the radio circuitry are further configured to perform one or more of the following:
receive the previous indication from a first network node;
perform, responsive to the previous indication, L1/L2 inter-cell mobility procedure, from the first network node to a second network node operating in the wireless communications network;
declare the failure;
perform the reestablishment procedure or reconnection procedure to a third network node operating in the wireless communications network; and
send any of the stored one or more indications to a network node operating in the wireless communications network and receive, based on the one or more indications sent, an updated inter-cell mobility procedure configuration from the network node, the updated configuration comprising adapted one or more procedures.

55. The wireless device according to claim 54, wherein the processing circuitry and the radio circuitry are configured to perform the reestablishment procedure after the wireless device goes to idle mode or after radio link failure.

56. The wireless device according to claim 54, wherein the reestablishment procedure fails and the wireless device reconnects to the network node, and the one or more indications further comprise at least one of the following:
a fifth indication of whether a second cell, selected by the wireless device for a reconnection procedure triggered by the failed reestablishment procedure, was a candidate cell in the inter-cell mobility configuration indicated by the previous indication, and
a sixth indication of a time elapsed between the following: a first time of reception of the inter-cell mobility configuration, and a fifth time of the reconnection upon selection of the second cell.

57. A network node configured to handle re-establishment information after a failure by a wireless device in a wireless communications network, the network node comprising:
radio circuitry configured to communicate with the wireless device; and
processing circuitry operably coupled to the radio circuitry, wherein the processing circuitry and the radio circuitry are configured to perform the method of claim 43.
